(19) United States
(12) Patent Application Publication
(10) Pub. No.: US 2025/0354835 A1
(43) Pub. Date: Nov. 20, 2025

(54) ROTATIONAL POSITION DETECTION DEVICE FOR STEPPING MOTOR

(71) Applicant: DENSO CORPORATION, Kariya-city (JP)

(72) Inventor: Yasumitsu OMI, Kariya-city (JP)

(21) Appl. No.: 19/282,897

(22) Filed: Jul. 28, 2025

Related U.S. Application Data
(63) Continuation of application No. PCT/JP2024/004760, filed on Feb. 13, 2024.

(30) Foreign Application Priority Data
Mar. 3, 2023 (JP) 2023-032911

(51) Int. Cl. G01D 5/244

(52) U.S. Cl. CPC G01D 5/244

(57) ABSTRACT

A rotational position detection device for a stepping motor is used for a stepping motor including a rotor with a plurality of magnets arranged in an annular shape, in order to detect a rotational position of the rotor. The rotational position detection device includes a magnetic flux sensor having a detection range at a predetermined position for detecting magnetism and detecting a change in magnetism according to rotation of the rotor. The magnets are arranged so that a polarity periodically changes according to a rotational direction of the rotor. The rotor has a peculiar magnetic flux point that interferes with a periodicity of a response waveform formed by the magnetism of the magnets detected by the magnetic flux sensor in a period of time for one rotation of the rotor.

### CROSS REFERENCE TO RELATED APPLICATION

The present application is a continuation application of International Patent Application No. PCT/JP2024/004760 filed on Feb. 13, 2024, which designated the U.S. and claims the benefit of priority from Japanese Patent Application No. 2023-032911 filed on Mar. 3, 2023. The entire disclosures of all of the above applications are incorporated herein by reference.

### TECHNICAL FIELD

The present disclosure relates to a rotational position detection device for a stepping motor.

### BACKGROUND

Conventionally, a rotational position detection device has been used for a stepping motor.

### SUMMARY

According to an aspect of the present disclosure, a rotational position detection device is for a stepping motor. The stepping motor includes a rotor with a plurality of magnets arranged in an annular shape. The rotational position detection device is configured to detect a rotational position of the rotor and comprises: a magnetic flux sensor having a detection range at a predetermined position for detecting magnetism and configured to detect a change in magnetism caused by rotation of the rotor. The magnets are arranged so that a polarity changes periodically according to a rotational direction of the rotor. The rotor may have a peculiar magnetic flux point configured to interfere with a periodicity of a response waveform, which is formed by the magnetism of the magnets detected by the magnetic flux sensor, in a period of time for one rotation of the rotor.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a cross-sectional view of an expansion valve of a first embodiment;

FIG. 2 is an illustration of a configuration of (a) a peculiar magnetic flux point of a rotor applied to the expansion valve and (b) a magnetic flux sensor of the first embodiment;

FIG. 3 is an illustration of an example of a condition in which a pseudo-normal waveform is generated;

FIG. 4 is an illustration of a relationship between the pseudo-normal waveform and a change in a magnetic flux intensity to the magnetic flux sensor;

FIG. 5 is an illustration of an example of a response waveform of the magnetic flux sensor of the first embodiment;

FIG. 6 is a flowchart of an error detection process for a stepping motor;

FIG. 7 is a flowchart of a rotor rotational position identification process of the stepping motor;

FIG. 8 is a flowchart of a speed adjustment process when the expansion valve is fully closed;

FIG. 9 is a flowchart of a retightening amount adjustment process for the expansion valve;

FIG. 10 is an illustration of the peculiar magnetic flux point of the rotor and the magnetic flux sensor applied to the expansion valve of a second embodiment;

FIG. 11 is an illustration of an example of the response waveform when the rotor rotates in an open valve direction in the expansion valve of the second embodiment;

FIG. 12 is an illustration of an example of the response waveform when the rotor rotates in a valve close direction in the expansion valve of the second embodiment; and

FIG. 13 is an illustration of the peculiar magnetic flux point of the rotor and the magnetic flux sensor applied to the expansion valve of a third embodiment.

### DETAILED DESCRIPTION

Hereinafter, examples of the present disclosure will be described. According to an example of the present disclosure, a rotational position detection device is used for a stepping motor. The stepping motor is for an expansion valve for air conditioning. The rotational position detection device detects a state of a motor using an output of a response waveform when a magnet placed on a rotor passes through a detection range of a magnetic flux sensor.

According to an example of the present disclosure, in addition to a case where the response waveform by the magnetic flux sensor is not output, when a length of period of the response waveform exceeds a threshold value, a determination is made to the effect that (a) the motor is out of step or (b) the motor has come to an abnormal stop.

In case of having a motor abnormality of a stepping motor, there may be a situation in which the response waveform from the magnetic flux sensor is output as the same waveform at the time of a normal operation, even though (a) the motor is out of step or (b) the motor has come to an abnormal stop. The response waveform output in such situation is hereafter referred to as a pseudo-normal waveform.

When time lapses in a state in which the pseudo-normal waveform is being output, the response waveform output from the magnetic flux sensor changes from a pseudo-normal waveform to an abnormal waveform, which may be that (a) the waveform is no longer output or (b) the length of period exceeds the threshold value. Therefore, a motor abnormality might be detectable in case that observation is continued for a certain period of time.

However, while waiting for the time to elapse, the motor abnormality may worsen, thereby (a) causing a discrepancy between a recognition on a controller side and an actual rotational position of the motor, and (b) making it difficult for realizing an accurate drive control of the motor. Therefore, for maintaining an accurate drive control of the motor, it would be necessary to quickly detect and address the motor abnormality.

Also, when a pseudo-normal waveform is output, measurement of the magnetic flux waveform by the magnetic flux sensor shows that an amplitude of the magnetic flux waveform is small. Here, the measurement of the amplitude of the magnetic flux waveform in a motor abnormality is smaller than the amplitude in a normal time, regarding which a case is considered where a sensor outputting the magnetic flux detection as an ON/OFF digital value, such as a Hall IC, is used. When an intensity of the magnetic flux exceeds a detection threshold value of the magnetic flux sensor under such condition, the magnetic flux sensor may eventually output a pseudo-normal waveform similar to the one in the normal time.

If, the magnetic flux waveform that has become smaller due to the motor abnormality can be eliminated by setting a certain detection threshold value to the magnetic flux sensor, a pseudo-normal waveform will not be output. However, it is difficult to set a detection threshold value that can reliably eliminate the output of the pseudo-normal waveform, considering the variation and deterioration of the magnet in the rotor and/or the variation of the magnetic flux sensor.

According to an example of the present disclosure, a rotational position detection device is for a stepping motor. The stepping motor includes a rotor with a plurality of magnets arranged in an annular shape. The rotational position detection device is configured to detect a rotational position of the rotor and comprises: a magnetic flux sensor having a detection range at a predetermined position for detecting magnetism and configured to detect a change in magnetism caused by rotation of the rotor. The magnets are arranged so that a polarity changes periodically according to a rotational direction of the rotor. The rotor has a peculiar magnetic flux point configured to interfere with a periodicity of a response waveform, which is formed by the magnetism of the magnets detected by the magnetic flux sensor, in a period of time for one rotation of the rotor.

Therefore, according to the rotational position detection device, when the rotor is rotating normally, the response waveform of the magnetic flux sensor output in the period of time of one rotation of the rotor includes a waveform caused by the peculiar magnetic flux waveform, thereby causing interference for periodicity.

In other words, the presence or absence of a waveform caused by a peculiar magnetic flux point can be used to determine whether it is in a situation in which the response waveform output from the magnetic flux sensor is showing a pseudo-normal waveform that changes periodically as in the normal time, even though the motor is actually out of step or is abnormally stopping.

That is, the rotational position detection device for a stepping motor can quickly detect abnormality of the stepping motor, which outputs a pseudo-normal waveform, according to the presence or absence of the waveform caused by the peculiar magnetic flux point in the response waveform from the magnetic flux sensor, thereby enabling prevention of progress of abnormality.

In the following, embodiments for carrying out the present disclosure are described with reference to the drawings. In each of the embodiments, portions corresponding to those described in the preceding embodiment are denoted by the same reference numerals, and redundant descriptions may be omitted. When only a part of a configuration is described in one embodiment, the other embodiments described above are applicable for the other parts of such configuration. The present disclosure is not limited to combinations of embodiments which combine parts that are explicitly described as being combinable. As long as no problem is present, the various embodiments may be partially combined with each other even if not explicitly described.

### First Embodiment

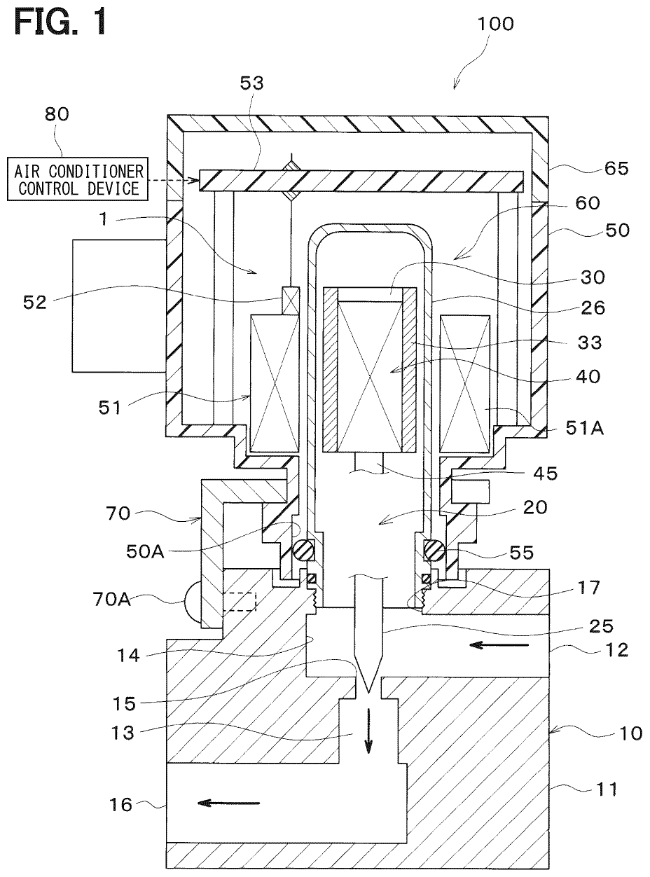

The first embodiment in the present disclosure is described with reference to FIGS. 1 through 9. In the first embodiment, a rotational position detection device of the present disclosure is applied to an expansion valve 100, which is one of the components in a vapor compression type refrigeration cycle. The refrigeration cycle includes a compressor, a condenser, the expansion valve 100 and an evaporator. The compressor sucks, compresses, and discharges refrigerant, and the condenser dissipates heat and condenses the refrigerant discharged from the compressor. The expansion valve 100 causes the refrigerant condensed in the condenser to decompress and expand, and the evaporator causes the refrigerant decompressed and expanded by the expansion valve 100 to absorb heat and evaporate.

First, a configuration of the expansion valve 100 to which the rotational position detection device is applied is explained with reference to the drawings. As shown in FIG. 1, the expansion valve 100 of the first embodiment is an electric expansion valve that adjusts an amount of pressure reduction by adjusting a valve opening (i.e., by changing an opening area according to a move of a valve plug 25), which is caused by converting a rotational force of a stepping motor 60 into vertical movement of the valve plug 25. That is, the expansion valve 100 is an electric expansion valve that uses a driving force to move the valve plug 25 to adjust an amount of refrigerant pressure reduction. That is, the rotational position detection device 1 detects a rotational position of a rotor 30 in the stepping motor 60 of the expansion valve 100. The rotational position detection device 1 detects a rotary operating state of the rotor 30 in the stepping motor 60 of the expansion valve 100 based on changes over time in the detected rotational position of the rotor 30.

The expansion valve 100 of the first embodiment includes a body 10, a lower case 50, an upper case 65, and a bracket 70. The body 10 includes a valve body 11, a valve plug 25, a bulkhead member 26 and the like.

The valve body 11 is a block-shaped member made of aluminum alloy or other material. As shown in FIG. 1, the valve body 11 includes a refrigerant channel 13 connecting an inlet 12 and an outlet 16 of the refrigerant. Further, in an inside of the valve body 11, a valve chamber 14 is formed above the refrigerant channel 13, and the valve plug 25 is slidably housed inside the valve chamber 14.

The inlet 12 is formed on one side of the valve body 11, and is where refrigerant circulating in the refrigeration cycle flows into the expansion valve 100. The inlet 12 is connected to the valve chamber 14 via the refrigerant channel 13.

The outlet 16 is formed on an underside of the valve body 11, through which the refrigerant circulating in the valve chamber 14 flows out of the expansion valve 100. A valve seat 15 is formed at the bottom of the valve chamber 14, connecting the valve chamber 14 to the outlet 16 via the refrigerant channel 13.

In the first embodiment, the inlet 12 is formed on one side of the valve body 11, and the outlet 16 is formed on the underside of the valve body 11. However, the expansion valve 100 is not limited to such configuration. For example, it is possible to adopt a configuration in which an inlet is formed on the underside of the valve body 11, and an outlet is formed on one side of the valve body 11. In such configuration, the configuration for driving the valve plug 25 (i.e., stepping motor 60, etc.) may be arranged on a low pressure side.

A through hole 17 is formed in tan upper part of the valve body 11. The through hole 17 is formed to connect a top surface of the valve body 11 with a center portion on a top surface of the valve chamber 14. A portion of the valve plug 25, which moves in the vertical direction by the driving force transmitted through an output shaft 45 of the stepping motor 60 and a power transmission unit 20, is arranged in an inside of the through hole 17.

The driving force from the rotor 30 of the stepping motor 60 arranged above the valve body 11 is transmitted to the valve plug 25 through the through hole 17 and the power transmission unit 20 arranged above it. The power transmission unit 20 includes a feed screw mechanism that converts a rotational motion generated by the rotor 30 into a linear motion, and transmits it to the valve plug 25.

The valve plug 25 moves in axial direction (i.e., up and down in FIG. 1) by the driving force from the rotor 30 to move closer to or away from the valve seat 15. In the expansion valve 100, the refrigerant channel can be closed by bringing the valve plug 25 into contact with the valve seat 15. Therefore, the valve plug 25 corresponds to an example of a movable member, and valve seat 15 corresponds to an example of a regulating unit.

A relative movement of the valve plug 25 with respect to the valve seat 15 adjusts a degree of opening of the refrigerant channel in the expansion valve 100. As the refrigerant flows through the refrigerant channel 13, the refrigerant is decompressed and expanded by a throttling action of a gap between the valve plug 25 and the valve seat 15, thereby allowing the expansion valve 100 to adjust the amount of refrigerant decompression by the adjustment of the degree of opening.

As shown in FIG. 1, the bulkhead member 26 is fixed to the top surface of the valve body 11. The bulkhead member 26 is a rotor housing member formed in a cylindrical shape by stainless steel or other metal, and accommodates the rotor 30. The bulkhead member 26 is coaxially arranged with the valve plug 25.

One end of the bulkhead member 26 (i.e., a top end in FIG. 1) is closed. The other end of the bulkhead member 26 (i.e., a lower end in FIG. 1) is open, and is sealingly contacting to the valve body 11. Therefore, a high-pressure refrigerant before depressurization exists in an interior space of the bulkhead member 26, and the bulkhead member 26 serves as a barrier between a refrigerant-containing circuit containing the high-pressure refrigerant and an outside. Specifically, an O-ring is arranged at a position between the bulkhead member 26 and the valve body 11, and the bulkhead member 26 and the valve body 11 are sealed and fixed by fastening a male thread formed on an outer circumference of the bulkhead member 26 and a female thread formed on an inner circumference of the valve body 11.

The rotor 30 is a rotor in the stepping motor 60, and rotates when a stator coil 51A of a stator 51, i.e., a stator of the motor 60, is energized. The rotor 30 rotates to generate a driving force to drive the valve plug 25. The stepping motor 60 is composed of the rotor 30 and the stator 51, and is employed as an electric actuator to displace the valve plug 25.

The rotor 30 includes a plurality of magnet pillars 33. The plurality of magnet pillars 33 are arranged at predetermined intervals along an outer circumference of the rotor 30, which is configured as a cylinder. The plurality of magnet pillars 33 are arranged so that S and N poles alternate in a circumferential direction of the rotor 30. A specific configuration of the rotor 30 will be explained in detail later.

The expansion valve 100 generates a driving force (i) to rotate the rotor 30 about a rotation shaft 31 and (ii) to move the valve plug 25 through (a) the action of the rotating magnetic field generated in the stator coil 51A of the stator 51 by energization and (b) the plurality of magnet pillars 33 of the rotor 30.

The driving force generated by the rotation of the rotor 30 is transmitted to an output shaft 45 via a planetary gear mechanism 40. The planetary gear mechanism 40 is arranged below the rotor 30, and reduces an angular velocity output by the rotor 30 according to a predetermined reduction ratio.

The planetary gear mechanism 40 includes a sun gear, a plurality of planetary gears, a fixed gear, and an output gear, although illustration is omitted. The planetary gear is arranged on an outer circumference of the sun gear, and the fixed gear, which is a ring gear, and the output gear are arranged on an outer circumference of the planetary gear. The sun gear is arranged in an inside of the planetary gear in the rotor 30, and is formed as an integral part of the rotor 30. Thus, the sun gear rotates in synchronization with the rotation of the rotor 30. A predetermined number of inner teeth are formed inside the ring-shaped fixed gear and the output gear. The output gear supports a plurality of planetary gears (three in the present embodiment)

in a rotatable manner. Each of the planetary gears is arranged at a position between an outer teeth of the sun gear and the inner teeth of the fixed gear, and is supported by the output gear so that it meshes with the outer teeth of the sun gear and the inner teeth of the fixed gear, respectively. The output gear and the output shaft 45 are integrated on the underside of the output gear.

The power transmission unit 20 is arranged below the rotor 30 and the planetary gear mechanism 40. As described above, the power transmission unit 20 includes (a) the feed screw mechanism for converting the rotation of the output gear to motion in a valve drive direction and (b) a mechanism for connecting the rotational force while absorbing (c) a shift of the feed screw mechanism in a rotation axis direction and (d) a shift of an output gear rotation unit. The power transmission unit 20 converts the rotational motion transmitted from the output shaft 45 into the linear motion, and transmits it to the valve plug 25 without changing a relative position of the rotor 30 in the axial direction of the expansion valve 100.

As shown in FIG. 1, the lower case 50 is attached to the top of the valve body 11. The lower case 50 is formed to enclose the bulkhead member 26 from the outside, and houses the stator 51, the bulkhead member 26, a magnetic flux sensor 52, and a control board 53. The lower case 50, together with the upper case 65, constitutes a waterproof case.

A bottom of the lower case 50 has an opening in a cylindrical part 50A into which the bulkhead member 26 is coaxially inserted. A gap between the cylindrical part 50A of the lower case 50 and the bulkhead member 26 has a sealing structure with an O-ring 55. The O-ring 55 is arranged at a position between the cylindrical part 50A and the bulkhead member 26 to suppress liquid from entering the interior of the lower case 50.

The stator 51 is arranged coaxially with the rotor 30 and the bulkhead member 26, outside in a radial direction of the rotor 30 and the bulkhead member 26. The stator 51 includes the stator coil 51A, which generates a rotating magnetic field to rotate the rotor 30 when the stator coil 51A is energized. A holder portion is formed at the top of the stator 51 to hold the magnetic flux sensor 52. The holder portion is formed by a molded resin unit that covers the outside of the stator coil 51A.

The magnetic flux sensor 52 is a magnetic flux density detector that detects a magnetic flux density and is composed of, for example, a Hall IC. In other words, the magnetic flux sensor 52 is a magnetic flux change detector that detects changes of the magnetic flux associated with the rotation of the rotor 30.

The magnetic flux sensor 52 has a detection range toward a rotor 30 side, and detects changes in the magnetic flux due to the plurality of magnet pillars 33 that pass through the detection range as the rotor 30 rotates. The magnetic flux sensor 52, for example, starts outputting an ON signal when the magnetic flux intensity pertaining to the magnet pillars 33 of the N pole (hereafter referred to as a magnet pillar 33N) arranged on the rotor 30 exceeds, due to the approach of the magnet pillars 33 to the detection range, a predetermined threshold value (an ON threshold value). When the magnetic flux intensity pertaining to the magnet pillars 33 of the S pole (hereinafter referred to as a magnet pole 33S) arranged on the rotor 30 exceeds the predetermined threshold value (an OFF threshold value) as the magnet pillars 33 of the S pole approaches the detection range, the magnetic flux sensor 52 starts outputting an OFF signal.

As described above, since the magnet pillars 33N and 33S are arranged alternately on the outer circumference of the rotor 30, when the rotor 30 is rotating normally, it basically outputs a response waveform in which the ON signal and the OFF signal are periodically repeated.

Also, since the magnetic flux sensor 52 is held above the stator 51, the positional accuracy of the magnetic flux sensor 52 relative to the rotor 30 is improvable compared to a case where the magnetic flux sensor 52 is held in the lower case 50. Thus, the detection accuracy of the magnetic flux density by the magnetic flux sensor 52 is improvable.

The control board 53 is arranged above the rotor 30, the bulkhead member 26, and the stator 51, in an inside of the lower case 50. The control board 53 is communicatively connected to an air conditioning controller 80 for controlling an operation of the refrigeration cycle, and controls an operation mode of the expansion valve 100 based on control instructions from the air conditioning controller 80. That is, the control board 53 controls the operation of the stepping motor 60 and a drive current to the stator coil 51A based on control instructions from the air conditioning controller 80.

Also, the control board 53 makes a determination regarding the rotational position of the rotor 30 in the stepping motor 60 based on a response signal of the magnetic flux sensor 52. That is, based on the response signal of the magnetic flux sensor 52, the control board 53 controls the drive of the stepping motor 60 according to (a) the presence or absence of errors in the stepping motor 60 and (b) the position of the rotor 30. The control board 53 corresponds to an example of a control unit.

The upper case 65 is a lid component for sealing the lower case 50. The lower case 50 and the upper case 65 are formed of resin. The lower case 50 is secured to the upper case 65 by plastic welding, such as laser welding. In such manner, a liquid-tight seal between the lower case 50 and the upper case 65 is achieved, preventing water from entering a space that contains electrical control components such as the control board 53 and the magnetic flux sensor 52.

The bracket 70 is a fixing member for fixing the lower case 50 to the valve body 11. racket 70 is constructed of stainless steel, and has a flat plate shape bent into an L-shape. One end of the bracket 70 is fastened to the valve body 11 with fastening screws 70A, while the other end of the bracket 70 firmly holds the cylindrical part 50A of the lower case 50.

According to the expansion valve 100 configured in such manner, based on a control instruction from the air conditioning controller 80, the drive current to the stator coil 51A is controlled by the control board 53, the rotational movement of the rotor 30 is controlled, and the position of the valve plug 25 relative to the valve seat 15 is adjusted. In such manner, the amount of refrigerant pressure reduction in the expansion valve 100 is appropriately controlled.

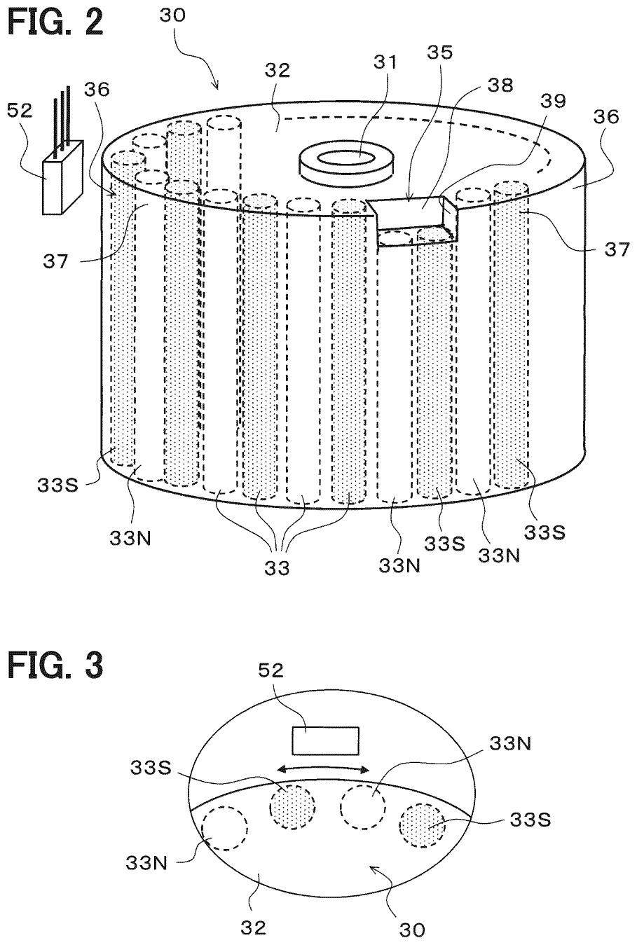

Next, the configuration of the rotor 30 of the stepping motor 60 in the expansion valve 100 of the first embodiment is described in detail with reference to FIG. 2. The rotor 30 of the stepping motor 60 of the first embodiment includes a rotor core 32 formed in a cylindrical shape with a closed top surface. At the center of the rotor core 32 in a cylinder shape is the rotation shaft 31 that serves as the center of rotation of the rotor 30. As described above, the rotation shaft 31 of the rotor 30 is coaxially arranged with output shaft 45, the valve plug 25, and the valve seat 15 in the expansion valve 100.

As described above, the plurality of magnet pillars 33 are arranged at predetermined intervals on the outer circumference of the rotor 30. The plurality of magnet pillars 33 consists of 12 pieces of the magnet pillars 33N and 12 pieces of the magnet pillars 33S, arranged so that the magnet pillars 33N and 33S alternate. The magnet pillar 33N is formed by molding an outer shape of a resin magnet by a resin molding process, and then magnetizing it to show the N polarity. The magnet pillar 33S is formed by molding a resin magnet by a resin molding process, and then magnetizing it to show the S pole polarity.

As shown in FIG. 2, the magnetic flux sensor 52 is arranged outside the rotor 30 in the radial direction, and its detection range is set to detect changes in the magnetic flux on an upper surface side of the outer circumference of the rotor 30.

Here, a peculiar magnetic flux point 35 is formed on the upper surface side of the rotor 30 in the first embodiment. The peculiar magnetic flux point 35 is a part of the rotor that causes interference to periodic changes in the magnetic flux generated in the magnetic flux sensor 52 by the alternation of the magnet pillars 33N and 33S at predetermined intervals.

The peculiar magnetic flux point 35 is composed of a combination of (a) a magnetic part 36, which is either S- or N pole magnetic, and (b) a non-magnetic part 38, which exhibits non-magnetic property, in a portion of the rotor 30 that passes through the detection range of the magnetic flux sensor 52.

The magnetic part 36 in the first embodiment is realized as an extension part 37, which is an extension of the magnet pillar 33 up to an upper surface portion of the rotor 30 that passes through the detection range of the magnetic flux sensor 52. Therefore, when the magnetic part 36 passes through the detection range of the magnetic flux sensor 52, the extension part 37 pertaining to the magnet pillar 33N and the extension part 37 pertaining to the magnet pillar 33S alternately pass therethrough.

Further, the non-magnetic part 38 in the first embodiment is formed as a notch 39 which is formed by notching an upper surface side portion of the rotor 30 including the magnet pillars 33, which passes through the detection range of the magnetic flux sensor 52. Specifically, the notch 39 of the rotor 30 in the first embodiment consists of, as shown in FIG. 2, a notch of the upper surface side portion of the rotor 30, including an upper surface side portion of one magnet pillar 33S and an upper surface side portion of an adjacent magnet pillar 33N respectively cut out from the rotor 30.

A range of the rotor 30 cut out as the notch 39 is defined based on the detection range of the magnetic flux sensor 52, and is defined so that no part of the magnet pillar 33S is included within the detection range. Further, when the rotor 30 is displaced in the axial direction (i.e., in the vertical direction) as it rotates due to the action of the feed screw mechanism, a part of the rotor 30 that passes through the detection range of the magnetic flux sensor 52 becomes wider in the axial direction as the rotor 30 is displaced. Therefore, in such case, the range of the rotor 30 to be cut out as the notch 39 is defined by taking into account (a) the detection range of the magnetic flux sensor 52 and (b) the amount of deviation of the rotor 30 in the axial direction due to rotation, for showing non-magnetic property of the notch 39.

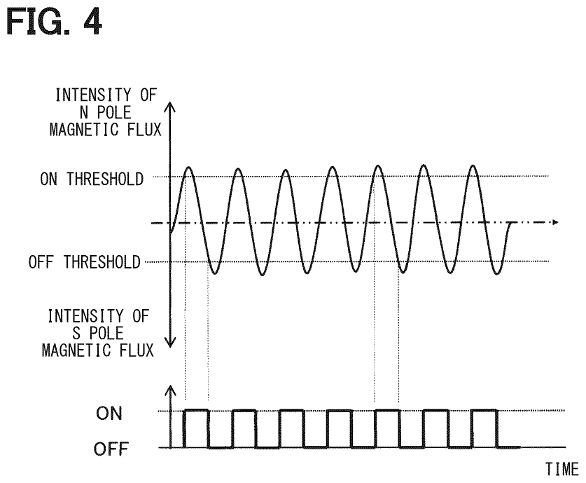

Next, the pseudo-normal waveforms that hinder the detection of the rotation abnormality in a rotor with the plurality of magnets by examining a period of the response waveform of the magnetic flux sensor are explained with reference to FIGS. 3 and 4. For example, it is known that CN107763285A describes a technique for detecting rotor slip (i.e., out-of-step) and rotation abnormality using plurality of magnets arranged on the rotor and the response period of the response waveform of the magnetic flux sensor.

As described above, the magnetic flux sensor starts outputting an ON signal when, for example, (a) the N pole magnet arranged on the rotor approaches the detection range and (b) the magnetic flux intensity pertaining to the N pole exceeds the ON threshold value. As the N pole magnet moves away from the detection range, the magnetic flux intensity pertaining to the N pole weakens.

Further, the magnetic flux sensor also starts outputting an OFF signal when (a) the S pole magnet arranged on the rotor approaches the detection range, and (b) the magnetic flux intensity pertaining to the S pole exceeds the OFF threshold value. As the S pole magnet moves away from the detection range, the magnetic flux intensity pertaining to the S pole weakens. Therefore, when the rotor is rotating normally, the response waveform of the magnetic flux sensor shows a waveform in which the ON and OFF signals are periodically repeated with a predetermined length (of time).

Now consider, for example, a situation in which, though the rotor is rotating, the rotation is out of step at times, and in particular, the response waveform in such situation. When a rotor slip/step-out occurs, it will take time for the S or N pole of the rotor to approach the detection range of the magnetic flux sensor. Therefore, in the response waveform of the magnetic flux sensor, the response period at the time of rotor slip becomes longer, thereby the presence or absence of rotor slip is detectable by comparing the length of the response period with that of normal response period.

Next, consider a situation in which the rotor does not rotate, but is induced to vibrate by the rotating magnetic field of the stator coil. When the rotor is induced to vibrate by the stator coil, the N pole and S pole magnets in the rotor approach the magnetic flux sensor alternately as the vibration occurs. If the magnetic flux intensity of the N pole and the magnetic flux intensity of the S pole exceed the ON and OFF threshold values, the ON and OFF signals are output.

For example, when the magnetic flux sensor and the N pole vibrate in close proximity, the magnetic flux intensity pertaining to the N pole exceeds the ON threshold value, but the magnetic flux intensity pertaining to the S pole does not exceed the OFF threshold value because the magnet pertaining to the S pole is arranged far from the detection range. Therefore, a rotation abnormality in which the magnetic flux sensor and the N pole vibrate in close proximity is detectable by comparing the response period, because the response waveform when the magnetic flux sensor and the N pole vibrate in close proximity shows a waveform in which the ON signal continues.

When the magnetic flux sensor and the S pole vibrate in close proximity, the magnetic flux intensity pertaining to the S pole exceeds the OFF threshold value, but the magnetic flux intensity pertaining to the N pole does not exceed the ON threshold value, because the magnet pertaining to the N pole is arranged far from the detection range. Therefore, a rotation abnormality in which the magnetic flux sensor and the S pole vibrate in close proximity is detectable by comparing the response period, because the response waveform when the magnetic flux sensor and the S pole vibrate in close proximity shows a waveform in which the OFF signal continues.

Then, consider a case where the rotor does not rotate but vibrates by being induced by the rotating magnetic field of the stator coil with a period different from an excitation period (period of applied pulses) of the stator coil. As described above, the N pole and S pole magnets in the rotor approach the detection range of the magnetic flux sensor alternately with vibration. In such case, even when the magnetic flux intensity pertaining to the N pole exceeds the ON threshold value and the magnetic flux intensity pertaining to the S pole exceeds the OFF threshold value, the response period of the ON and OFF signals corresponds to the period pertaining to rotor vibration and shows a different period from the excitation period of the stator coil. Therefore, by comparing the response period of the magnetic flux sensor, it is possible to detect rotation abnormality where the rotor vibrates with respect to the detection range of the magnetic flux sensor at a period different from the excitation period of the stator coil.

Here, consider a case where the rotor does not rotate but vibrates by being induced by the rotating magnetic field of the stator coil with the same period as the excitation period of the stator coil. In such case, as shown in FIG. 3, the magnetic flux sensor 52 is assumed to vibrate at a position that is near the center of the magnet pillars 33N and 33S.

When vibration is induced by the rotating magnetic field of the stator coil 51A, the magnet pillar 33N approaches the detection range of the magnetic flux sensor 52. At the time of vibration, even when the magnet pillar 33N comes closest to the detection range of the magnetic flux sensor 52, the magnetic flux intensity pertaining to the N pole shows a value greater than the ON threshold value, but such a value is smaller than the one when the rotor 30 rotates normally.

Because of the vibration induced by the rotating magnetic field of the stator coil 51A, when the magnet pillar 33N leaves the detection range and returns to its original position, the magnet pillar 33S moves closer to the detection range of the magnetic flux sensor 52. In such case, even when the magnet pillar 33S comes closest to the detection range of the magnetic flux sensor 52, the magnetic flux intensity pertaining to the S pole shows a value greater than the OFF threshold value, but such a value is smaller than the one when the rotor 30 rotates normally.

Therefore, as shown in FIG. 4, when the stator coil 51A vibrates by being induced by the rotating magnetic field of the stator coil 51A, the ON signal output is started when the magnet pillar 33N approaches the detection range of the magnetic flux sensor 52. The output of the OFF signal is then started when the magnet pillar 33S approaches the detection range of the magnetic flux sensor 52.

Further, in such case, because the vibration of the rotor 30 has the same period as the excitation period of the stator coil 51A, the response waveform from the magnetic flux sensor 52 will show the same waveform as the response waveform when the rotor 30 is rotating normally (i.e., shows a normal waveform). In the present disclosure, a response waveform that is output from the magnetic flux sensor 52 with the same waveform as when the rotor 30 is rotating normally, even though a rotation abnormality of the rotor 30 is occurring, is called as a pseudo-normal waveform.

When the rotor 30 is vibrating in a manner shown in FIG. 3, the response waveform from the magnetic flux sensor 52 is output. In such case, according to the technology described in CN107763285A, the response waveform by the magnetic flux sensor 52 (i.e., a pseudo-normal waveform) has the same response period as the normal waveform, thereby seemingly making it impossible to detect a situation in which vibration of the rotor is induced by the rotating magnetic field of the stator 51.

In the rotor 30 of a stepping motor applied to an expansion valve, if vibration is caused by the rotating magnetic field of the stator coil 51A, detection of the rotation abnormality is delayed due to the pseudo-normal waveform. In such case, a controller side that performs the drive control of the expansion valve recognizes that the valve is in a normal state, but the rotor of the stepping motor is in a state in which vibration continues, increasing a gap between the position recognized by the controller side and the actual position of the stepping motor increases with the passage of time.

As a result, in the operation control of the refrigeration cycle, an error is included in the adjustment of the valve opening degree of the expansion valve, and the refrigerant flow rate in the refrigeration cycle deviates from an assumption of the controller side, thereby affecting the performance of the refrigeration cycle.

In addition, the degree of opening of the expansion valve in the refrigeration cycle affects the amount of refrigeration oil contained in the refrigerant that is returned to the compressor. Therefore, when an error is caused in the adjustment of the valve opening degree of the expansion valve, such an error may be an abnormality causing factor, causing abnormality of components in the refrigeration cycle.

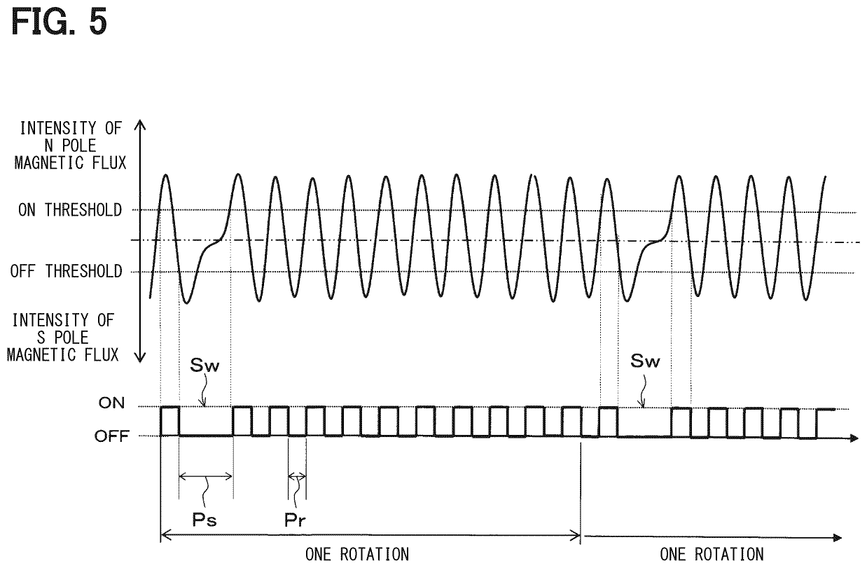

Next, the normal waveform in the expansion valve 100 of the first embodiment is explained with reference to FIG. 5. As described above, in the expansion valve 100 of the first embodiment, when the rotor 30 of the stepping motor 60 rotates, the magnetic part 36 and the non-magnetic part 38 arranged on the upper surface side of the rotor 30 pass through the detection range of the magnetic flux sensor 52.

As described above, as the rotor 30 rotates, the magnetic flux intensity pertaining to the N pole increases as the extension part 37 of the magnet pillar 33N approaches the detection range of the magnetic flux sensor 52. When the magnetic flux intensity pertaining to the N pole exceeds the ON threshold value, the magnetic flux sensor 52 outputs an ON signal.

As the extension part 37 of the magnet pillar 33N passes through and moves away from the detection range of the magnetic flux sensor 52, at the same time, the extension part 37 of the magnet pillar 33S approaches the detection range of the magnetic flux sensor 52. As the extension part 37 of the magnet pillar 33S approaches the detection range of the magnetic flux sensor 52, the magnetic flux intensity pertaining to the S pole increases. When the magnetic flux intensity pertaining to the S pole exceeds the OFF threshold value, the magnetic flux sensor 52 outputs an OFF signal. As the extension part 37 of the magnet pillar 33S passes through and moves away from the detection range of the magnetic flux sensor 52, at the same time, the extension part 37 of the magnet pillar 33N approaches the detection range of the magnetic flux sensor 52.

With such series of operations, in the first embodiment, the ON and OFF signals are repeatedly switched when the magnetic part 36 passes through the detection range of the magnetic flux sensor 52. The period of the ON and OFF signals when the magnetic part 36 passes through the detection range of the magnetic flux sensor 52 is called as a normal period Pr.

As shown in FIG. 2, the magnetic part 36 and the non-magnetic part 38 are arranged on the upper surface side of the rotor 30, and the combination of the magnetic part 36 and the non-magnetic part 38 constitutes the peculiar magnetic flux point 35.

In the first embodiment, when the magnetic part 36 passes through the detection range of the magnetic flux sensor 52, the magnetic flux sensor 52 outputs a response waveform in which the ON and OFF signals switch at the normal period Pr. When the non-magnetic part 38 passes through the detection range of the magnetic flux sensor 52, the magnetic flux sensor 52 outputs a response waveform in which the ON and OFF signals switch at a longer period than the normal period Pr. In the first embodiment, in the response waveform of the magnetic flux sensor 52, the waveform in which the ON and OFF signals are switched at a longer period than the normal period Pr by the non-magnetic part 38 is called as a peculiar waveform Sw.

The peculiar waveform Sw and a peculiar waveform period Ps are explained with reference to FIG. 5. As the rotor 30 of the stepping motor 60 rotates and the magnetic part 36 passes through the detection range of the magnetic flux sensor 52, the non-magnetic part 38 approaches the detection range of the magnetic flux sensor 52. In an example shown in FIG. 5, as the non-magnetic part 38 approaches the detection range of the magnetic flux sensor 52, the extension part 37 of the magnet pillar 33S, which constitutes the magnetic part 36, passes through the detection range of the magnetic flux sensor 52 and moves away from the detection range. During such time, the magnetic flux intensity of the S pole weakens as the extension part 37 of the magnet pillar 33N moves away therefrom.

Note that the response signal of the magnetic flux sensor 52 at such point in time indicates the OFF signal that is output when the magnetic flux intensity of the S pole exceeds the OFF threshold value as the magnet pillar 33S approaches the detection range of the magnetic flux sensor 52.

When the non-magnetic part 38 approaches the detection range of the magnetic flux sensor 52, the intensity of the magnetic flux detected by the magnetic flux sensor 52 is caused only by the magnetic flux originating from the magnetic part 36, since the magnetic flux from the non-magnetic part 38 is not detected. Therefore, during a period when the non-magnetic part 38 passes through the detection range of the magnetic flux sensor 52, the magnetic flux sensor 52 continues to output an OFF signal.

As the non-magnetic part 38 passes through the detection range of the magnetic flux sensor 52, the extension part 37 of the magnet pillar 33N, which constitutes the magnetic part 36, approaches the detection range of the magnetic flux sensor 52. Accordingly, the magnetic flux intensity of the N pole intensifies as it approaches the detection range of the magnetic flux sensor 52. When the magnetic flux intensity of the N pole exceeds the ON threshold value, the magnetic flux sensor 52 outputs an ON signal. The output of the ON signal at such timing defines an end timing of the peculiar waveform Sw. The peculiar waveform period Ps, which is a period of the peculiar waveform Sw, is three times longer than the normal period Pr in the first embodiment.

In the first embodiment, as shown in FIG. 2, because the non-magnetic part 38 is formed at one position on the upper surface side of the rotor 30, while the other portion consists of the magnetic part 36, one peculiar magnetic flux point 35 is formed in the rotor 30. Therefore, after completion of the output of the peculiar waveform Sw, the ON and OFF signals are switched and output in the normal period in a time of one rotation.

In other words, in the expansion valve 100 of the first embodiment, if the response waveform of the magnetic flux sensor 52 in the period of at least one rotation of the rotor 30 includes a peculiar waveform Sw caused by the peculiar magnetic flux point 35, it indicates that the rotor 30 is rotating. In such manner, it is possible to distinguish the normal waveforms from the pseudo-normal waveforms depending on whether the response waveform of the magnetic flux sensor 52 includes the peculiar waveform Sw or not, thereby making it possible to detect rotation abnormality of the rotor 30, such as the rotor 30 vibrating as shown in FIG. 3.

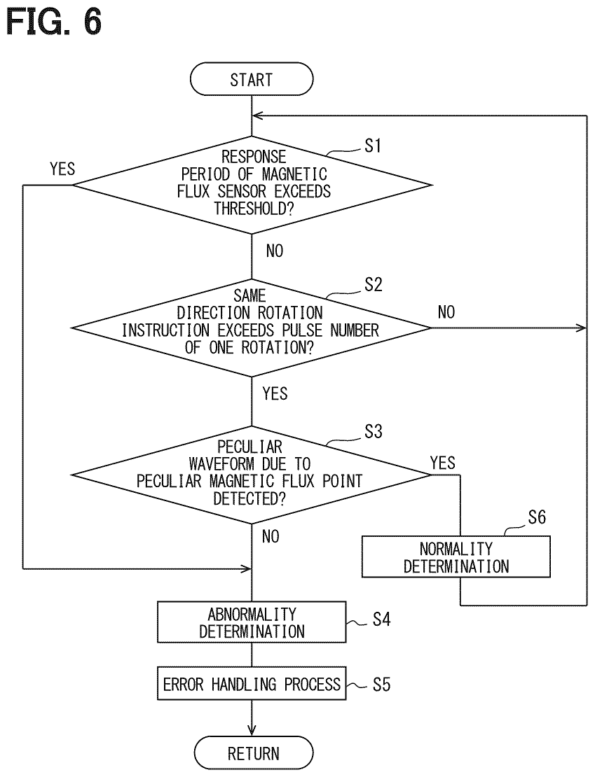

Next, an error detection process for detecting whether or not the rotor 30 of the stepping motor 60 has a rotation abnormality in the expansion valve 100 of the first embodiment is described with reference to FIG. 6. In the expansion valve 100 of the first embodiment, when the operation of the refrigeration cycle including the expansion valve 100 is started, the control board 53 starts performing the error detection process.

First, in step S1, it is determined whether the response period in the response waveform of the magnetic flux sensor 52 exceeds a threshold value. The stepping motor 60 is driven to rotate the rotor 30, and a determination process of step S1 is performed on the response waveform output from the magnetic flux sensor 52. The threshold value in step S1 indicates a range of the response period that can be taken when the rotor 30 is rotating normally, and is determined based on an application period of an excitation current to the stator coil 51A (i.e., period of applied pulses).

When the response period in the response waveform of the magnetic flux sensor 52 exceeds the threshold value, the process proceeds to step S4 and determines that a rotation abnormality of the rotor 30 has occurred. On the other hand, when the response period of the magnetic flux sensor 52 does not exceed the threshold value, the process proceeds to step S2.

An example of a rotation abnormality of the rotor 30 determined in the determination process of step S1 includes a case in which the rotor 30 occasionally goes out of step while operating normally. This is because a rotation abnormality in the rotor 30 affects the length of the response period of the magnetic flux sensor 52. Further, according to the determination process in step S1, even when the response waveform different from the pseudo-normal waveform is output from the magnetic flux sensor 52 while the rotor 30 is not rotating and is vibrating which is induced by the rotating magnetic field of the stator coil 51A, it can also be determined as a rotation abnormality.

In step S2, it is determined whether a control instruction from the air conditioning controller 80 is a rotation instruction in the same direction, and whether or not the number of excitation currents (pulses) exceeds the one for one rotation. In other words, it is determined whether or not a state in which the peculiar waveform Sw caused by the peculiar magnetic flux point 35 is detected at least once or more is instructed as a mode of drive control for the expansion valve 100.

When (a) the control instruction from the air conditioning controller 80 is a rotation instruction in the same direction, and (b) the number of excitation currents (number of pulses) exceeds the number for for one rotation, the process proceeds to step S3 because it indicates a state in which the response waveform from the magnetic flux sensor 52 includes a peculiar waveform Sw. On the other hand, when the control instruction from the air conditioning controller 80 (i) is a mixture of forward and reverse rotation instructions or (ii) is less than the number of excitation currents (pulses) for one rotation of the rotor 30, the process returns to step S1. In such case, the reason for such return is that a part that has passed through the detection range of the magnetic flux sensor 52 due to the rotation of the rotor 30 might possibly be the one that does not include the peculiar magnetic flux point 35.

In step S3, it is determined whether the response waveform from the magnetic flux sensor 52 includes a peculiar waveform Sw caused by the peculiar magnetic flux point 35. As described above, in the first embodiment, one peculiar magnetic flux point 35 is formed on a circumference of the upper surface side portion of the rotor 30. Thus, when the response waveform for a period of time sufficient for one rotation of the rotor 30 includes one peculiar waveform Sw, it indicates that the rotor 30 is rotating normally. In such case, the process proceeds to step S6, and determines that the rotation of the rotor 30 is normal. The process then returns to step S1.

On the other hand, when the response waveform for a period of time sufficient for one rotation of the rotor 30 does not include one peculiar waveform Sw, it indicates a state (a) that the rotor 30 is vibrating which is induced by the rotating magnetic field of the stator coil 51A, and (b) that a pseudo-normal waveform is being output. Therefore, when one peculiar waveform Sw is not included in the response waveform for a period of time sufficient for one rotation of the rotor 30, a determination is made to the effect that a rotation abnormality of the rotor 30 has occurred. After determining in step S4 that a rotation abnormality of the rotor 30 has occurred, an error response process is performed in step S5. In the error response process, for example, an error signal is output from the control board 53 to the air conditioning controller 80, indicating that a rotation abnormality of the rotor 30 has occurred. In such error signal, a signal instructing a user to report an error may be included on the air conditioning controller 80 side. Simultaneously with the output of the error signal, a control mode regarding the operation of the expansion valve 100 may be changed. After the error response process is completed, the error detection process is terminated.

According to the rotational position detection device 1 of the first embodiment, by (a) forming the peculiar magnetic flux point 35 in the rotor 30 of the stepping motor 60 and (b) performing the error detection process shown in FIG. 6, it is possible to detect a rotation abnormality in the rotor 30 in a manner in which a pseudo-normal waveform is output from the magnetic flux sensor 52.

In such manner, in addition to responding to the rotation abnormality of the rotor 30 identified by the response period in the response waveform from the magnetic flux sensor 52, it is possible to respond to the rotation abnormality of the rotor 30 when the pseudo-normal waveform is output, thereby ensuring that the performance of the expansion valve 100 and the refrigeration cycle is maintained.

When a configuration in which the magnetic flux of the plurality of magnets in the rotor 30 is detected by the magnetic flux sensor 52 is adopted, if the peculiar magnetic flux point 35 is formed in the part of the rotor 30 that passes through the detection range of the magnetic flux sensor 52, the configuration can be made to detect the rotation abnormality related to the pseudo-normal waveform.

Next, the manner of controlling the drive of the stepping motor 60 using the detection of the peculiar waveform Sw by the magnetic flux sensor 52 when the rotor 30 is rotating normally will be explained with reference to the drawings.

First, the expansion valve 100 of the first embodiment can perform a rotor rotational position identification process to identify the rotational position of the rotor 30 using a fact that the peculiar waveform Sw is detected when the rotor 30 is rotating normally.

As described above, the rotational position detection device 1 for the first embodiment is applied to the expansion valve 100, and the rotational position of the rotor 30 corresponds to the position of the valve plug 25, which corresponds to a movable member. Therefore, it is possible to identify the position of the valve plug 25 in the expansion valve 100 (i.e., the valve opening degree in the expansion valve 100) by performing the rotor rotational position identification process.

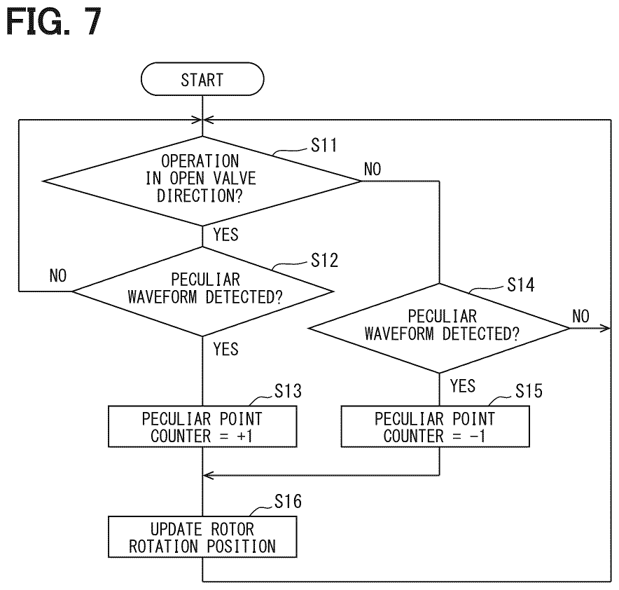

Referring to FIG. 7, the rotor rotational position identification process is explained. Here, the execution of the rotor rotational position identification process starts when the valve plug 25, which is a movable member of the expansion valve 100, (a) contacts the valve seat 15, which is a regulating unit, and (b) is in a drive initial position, which is a closed state as the expansion valve 100. That is, for example, a timing of when the expansion valve 100 is adjusted to the closed state at the end of the operation of the refrigeration cycle, and the operation of the refrigeration cycle is started again may correspond to such situation.

First, in step S11, it is determined whether an operation of the stepping motor 60 is in a direction in which the valve plug 25 leaves the valve seat 15 (i.e., in the open valve direction). The determination process of step S11 is performed according to the content of the control instruction output from the air conditioning controller 80 and the mode of the excitation current to the stator coil 51A, which is output from the control board 53. When the stepping motor 60 is operating in the open valve direction, the process proceeds to step S12. On the other hand, when the stepping motor 60 is operating in the close valve direction, the process proceeds to step S14.

In step S12, it is determined whether or not a peculiar waveform Sw is detected in the response waveform output from the magnetic flux sensor 52 due to the operation of the stepping motor 60 in the open valve direction. When the peculiar waveform Sw is detected in the response waveform due to the operation of the stepping motor 60 in the open valve direction, the process proceeds to step S13, and a peculiar point counter is incremented by 1. The peculiar point counter is stored in a memory device (e.g., RAM) on the control board 53. After adding 1 to the peculiar point counter, the process proceeds to step S16. On the other hand, when the peculiar waveform Sw is not detected in the response waveform due to the operation of the stepping motor 60 in the open valve direction, the process returns to step S11.

Here, when the stepping motor 60 operates in the open valve direction, the rotor 30 continuously rotates in a predetermined direction. As described above, in the expansion valve 100 of the first embodiment, when the rotor 30 makes one rotation, the response waveform of the magnetic flux sensor 52 should include one peculiar waveform Sw. Therefore, by counting the number of the peculiar waveforms Sw, an amount of rotation of the rotor 30 in the open valve direction is identified. Further, since the amount of rotation of the rotor 30 corresponds to an amount of deviation of the valve plug 25, the amount of deviation of the valve plug 25 in the open valve direction of the expansion valve 100 is identified.

In step S14, it is determined whether or not a peculiar waveform Sw is detected in the response waveform output from the magnetic flux sensor 52 due to the operation of the stepping motor 60 in the close valve direction. When the peculiar waveform Sw is detected in the response waveform due to the operation of the stepping motor 60 in the close valve direction, the process proceeds to step S15, and the peculiar point counter is decremented by 1. After subtracting 1 from the peculiar point counter, the process proceeds to step S16. On the other hand, when the peculiar waveform Sw is not detected in the response waveform due to the operation of the stepping motor 60 in the close valve direction, the process returns to step S11.

When the stepping motor 60 operates in the close valve direction, the rotor 30 continuously rotates in an opposite direction of a valve opening operation. Therefore, the amount of rotation of the rotor 30 in the close valve direction can be identified by counting the peculiar waveform Sw in the response waveform when the valve is operated in the close valve direction. Further, since the amount of rotation of the rotor 30 corresponds to the amount of deviation of the valve plug 25, the amount of displacement of the valve plug 25 in the closing direction in the expansion valve 100 is identified.

In step S16, the rotational position of the rotor 30 is updated based on the value of the peculiar point counter updated in steps S13 and S16. In other words, the position of the valve plug 25 in the expansion valve 100 is updated based on the value of the peculiar point counter. After updating the rotational position of the rotor 30, the process returns to step S11 to repeat the rotor rotational position identification process.

As described above, the rotor rotational position identification process starts in a valve closed state, i.e., when the valve plug 25 is in contact with the valve seat 15. Thus, the value of the peculiar point counter indicates a relative positional relationship of the valve plug 25 with respect to the valve seat 15. Therefore, the numerical value of the peculiar point counter can be used to identify the valve opening degree of the expansion valve 100.

According to the rotational position detection device 1 of the first embodiment, by utilizing the peculiar magnetic flux point 35 formed in the rotor 30, the rotational position of the rotor 30 in the stepping motor 60 can be accurately identified while improving the detection accuracy of the rotation abnormality related to the pseudo-normal waveform.

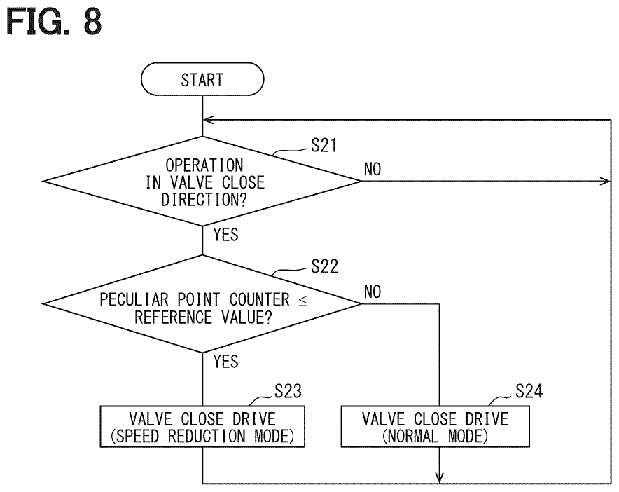

Next, an example of drive control of the stepping motor 60 using the value of the peculiar point counter updated in the above-mentioned rotor rotational position identification process is explained with reference to FIG. 8. FIG. 8 is a flowchart showing the drive control of the stepping motor 60 when the valve plug 25 is brought into contact with the valve seat 15 of the expansion valve 100 to put it in the valve closed state.

Here, in the expansion valve, since the valve plug 25 is pressed against the valve seat 15 to close the valve, noise due to collision is frequently generated when the valve seat 15 and the valve plug 25 come into contact. In addition, because of the frequency of contact between the valve seat 15 and the valve plug 25, both parts may be worn or deformed by contact or other factors. Deformation and wear of the valve seat 15 and the valve plug 25 are considered to progress more significantly as the speed at which the valve plug 25 contacts the valve seat 15 increases.

In view of the above, the flowchart shown in FIG. 8 uses the value of the peculiar point counter to realize a speed adjustment process when performing the valve closing operation of the expansion valve 100.

As shown in FIG. 8, first, in step S21, it is determined whether the expansion valve 100 is operated in the close valve direction. In the determination process in step S21, the same method as in step S11 is used to make the determination. When the operation of the expansion valve 100 is in the close valve direction, the process proceeds to step S22. On the other hand, when the operation is in the open valve direction of the expansion valve 100, the process waits. The drive of the stepping motor 60 in the open valve direction is realized as a process different from the one in the flowchart of FIG. 8.

In step S22, it is determined whether the value of the peculiar point counter, which is updated in the rotor rotational position identification process, is equal to or lower than a reference value. As described above, in the rotor rotational position identification process, the value of the peculiar point counter is set so that the valve closed state in which the valve plug 25 is in contact with the valve seat 15 is represented by the value 0, because the valve closed state in which the valve plug 25 is in contact with the valve seat 15 is the initial state. Therefore, in step S22, it is determined whether the operation in the close valve direction at the expansion valve 100 is immediately before the valve closed state. Thus, the reference value is defined as the value of the peculiar point counter (e.g., 1), which indicates the state immediately before the valve plug 25 comes into contact with the valve seat 15.

When the value of the peculiar point counter is greater than the reference value, the valve plug 25 is positioned far enough from the valve seat 15, and the process proceeds to step S24 to perform a valve closing drive of the expansion valve 100 in a normal mode.

In the valve closing drive in the normal mode in step S24, the operation of the stepping motor 60 is controlled so that the rotation speed of the rotor 30 (i.e., the movement speed of the valve plug 25) is in accordance with the control instruction output from the air conditioning controller 80. After the valve closing drive in the normal mode is terminated, the process returns to step S21.

On the other hand, when the value of the peculiar point counter is equal to or less than the reference value, the valve plug 25 is approaching the valve seat 15 and is immediately before the valve closed state. Thus, the process proceeds to step S23 to perform the valve closing drive of the expansion valve 100 in a speed reduction mode.

In the valve closing drive in the speed reduction mode in step S23, the operation of the stepping motor 60 is controlled so that the rotation speed of the rotor 30 is slower than the one in the valve closing drive in the normal mode. For example, in the drive control in the speed reduction mode, the rotation speed of the rotor 30 is adjusted to 50% of the rotation speed of the rotor 30 specified in the control instruction output from the air conditioning controller 80. After the valve closing drive in the speed reduction mode is terminated, the process returns to step S21.

In the valve closing drive in the speed reduction mode, it is appropriate as long as the rotation speed of the rotor 30 is slower than the one in the valve closing drive in the normal mode, and the speed reduction mode is not limited to the one relative to the normal mode. For example, the rotation speed of the rotor 30 may be lowered in steps as the valve plug 25 approaches the valve seat 15.

According to the rotational position detection device 1 of the first embodiment, the position of the valve plug 25 relative to the valve seat 15 can be identified by (a) forming the peculiar magnetic flux point 35 in the rotor 30 in the stepping motor 60 of the expansion valve 100 and (b) detecting the peculiar magnetic flux point 35 with the magnetic flux sensor 52.

When the rotational position detection system 1 detects that the expansion valve 100 is immediately before the valve closed state by using the value of the peculiar point counter during the valve closing operation, it performs the valve closing drive in the speed reduction mode. In such manner, the speed at which the valve plug 25 comes into contact with the valve seat 15 when shifting to the valve closed state is reducible, thereby suppressing the degree of deformation and wear of the valve seat 15 and the valve plug 25.

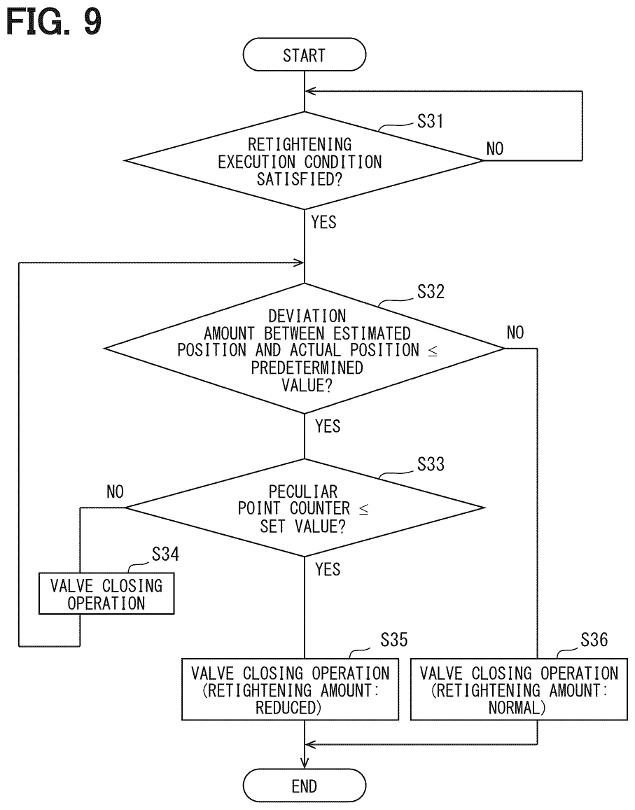

Next, another example of drive control of the stepping motor 60 using the value of the peculiar point counter updated in the rotor rotational position identification process described above is explained with reference to FIG. 9. FIG. 9 is a flowchart showing an adjustment control of an amount of retightening in a retightening operation to compensate for a difference between the actual position and the position recognized by a control circuit with respect to the rotational position of the rotor 30 in the stepping motor 60.

In the stepping motor 60, an amount of drive of the stepping motor 60 is recognized by the number of applied pulses of the excitation current applied to the stator coil 51A. When a rotation abnormality such as an out-of-step rotation occurs, the recognized position and the like on the control side, such as the air conditioning controller 80, may deviate from the actual rotational position and the like of the rotor 30, resulting in a mismatch therebetween.

In the drive control of the stepping motor 60, when an amount of deviation between the actual rotational position of the rotor 30 and the recognized position on the controller side becomes unacceptably large, the accuracy of the drive control of the stepping motor 60 is improvable by correcting the amount of deviation to have a value within an acceptable range.

When the stepping motor 60 is employed as a drive source in the expansion valve 100, as in the first embodiment, the performance of the expansion valve 100 and the refrigeration cycle can be ensured reliably and quickly by making appropriate correction for the amount of deviation.

The flowchart shown in FIG. 9 is performed when the valve closing operation in the expansion valve 100 is performed. In step S31, it is determined whether or not a retightening execution condition is satisfied. The retightening execution condition is a start condition for correcting the amount of deviation between the actual rotational position of the rotor 30 and the recognized position on the controller side. When the retightening execution condition is satisfied, the process proceeds to step S32. On the other hand, when the retightening execution condition is not satisfied, the process waits.

Here, specific examples of the retightening execution condition are described. For example, one example of such condition is when the expansion valve 100 has been used for a long period of time and the amount of deviation has become large enough to exceed the acceptable amount. Retightening in such case is performed when the drive of the refrigeration cycle is stopped. Further, other examples of such condition for retightening may include (a) the occurrence of deviation of a greater than predetermined amount after a short period of use of the expansion valve 100, or (b) experiencing high frequency of opening and closing operations of the expansion valve 100. Retightening in such case is performed in a course of putting the expansion valve 100 in a valve closed state.

In step S32, it is determined whether the amount of deviation between an estimated position of the rotor 30 estimated based on the control instruction from the air conditioning controller 80 and the actual position of the rotor 30 identified using the counting results of the peculiar point counter is equal to or less than a predetermined value.

Here, the estimated position of the rotor 30 corresponds to the recognized position on the controller side and is estimated based on the control instruction from the air conditioning controller 80. Specifically, the estimated position of the rotor 30 is estimated based on the number of pulses of applied excitation current applied to the stator coil 51A, which is included in the control instruction from the air conditioning controller 80.

The actual position of the rotor 30 is determined based on the value of the peculiar point counter, which is updated in the rotor rotational position identification process shown in FIG. 7. In addition to the value of the peculiar point counter, other information may be used in identifying the actual position of the rotor 30. For example, in the response waveform from the magnetic flux sensor 52, the actual position of the rotor 30 can be identified in more detail by using the number of switching times of the ON and OFF signals in the normal period Pr output when the magnetic part 36 passes through the detection range of the magnetic flux sensor 52.

The amount of deviation in step S32 is determined as a difference between the estimated position of the rotor 30 and the actual position of the rotor 30, which is determined in the above-described manner. The predetermined value in step S32 is defined as the difference between the estimated position of the rotor 30 and the actual position of the rotor 30 as an acceptable range. In determining the predetermined value, the operating history of the expansion valve 100 and the refrigeration cycle can be taken into consideration.

When the amount of deviation is equal to or less than a predetermined value, the process proceeds to step S33. On the other hand, when the amount of deviation is larger than the predetermined value, it indicates that the amount of deviation is large enough to affect the performance of the expansion valve 100 and the refrigeration cycle, and therefore, the process proceeds to step S36, where the valve closing operation of the expansion valve 100 is performed with a normal amount of retightening. Specifically, the rotor 30 is rotated in the close valve direction by a pre-determined amount of retightening from the valve closed state in which the valve plug 25 is in contact with the valve seat 15. When the valve closing operation including the normal amount of retightening is terminated in step S36, the retightening amount adjustment process shown in FIG. 9 is terminated.

In step S33, it is determined whether the value of the peculiar point counter is equal to or less than a set value. The set value in such case is defined as a value of the peculiar point counter, which indicates a state immediately before the valve plug 25 comes into contact with the valve seat 15. Therefore, in other words, it is, in step S33, determined whether the operation in the close valve direction at the expansion valve 100 is immediately before the valve closed state.

When the value of the peculiar point counter is equal to or less than the set value, which is a situation in which the valve plug 25, contacting the valve seat 15, is in such timing immediately before the valve closed state, the process proceeds to step S35, and the valve closing operation of the expansion valve 100 is performed in a state in which the amount of retightening is reduced. The amount of retightening realized in the valve closing operation in step S35 is defined to be smaller than an amount of retightening performed in step S36. On the other hand, when the value of the peculiar point counter is greater than the set value, which is a situation in which the valve plug 25 is being positioned away from the valve seat 15, the process proceeds to step S34, and the valve closing operation of the expansion valve 100 is performed.

The valve closing operation in step S34 is realized by rotating the rotor 30 in a predetermined direction so that the valve plug 25 approaches the valve seat 15 in accordance with the control instruction from the air conditioning controller 80. After the valve closing operation of step S34 is terminated, the process returns to step S32.

Then, the amount of deviation between the estimated position of the rotor 30 and the actual position of the rotor 30 is smaller when proceeding to step S35 than when proceeding to step S36. That is, in step S35, a 0 (zero) deviation amount correction is performed, with a small amount of retightening, depending on the magnitude of the deviation between the estimated position of the rotor 30 and the actual position of the rotor 30. When the valve closing operation including retightening with the reduced amount of retightening is terminated in step S35, the retightening amount adjustment process shown in FIG. 9 is terminated.

As shown in FIG. 9, the rotational position detection device 1 of the first embodiment adjusts the amount of retightening performed during the valve closing operation according to the magnitude of the amount of deviation between the estimated position of the rotor 30 and the actual position of the rotor 30. In such manner, appropriate adjustment of the load on (i) the stepping motor 60 and accompanying drive components and (ii) abnormal noise generation time, in a situation such as when retightening is performed with a large amount of retightening when the amount of deviation is relatively small, or in other situations.

As a result, according to the rotational position detection device 1, an excessive load on the stepping motor 60, and the like of the expansion valve 100 is reducible by performing the retightening amount adjustment process shown in FIG. 9. Therefore, the rotational position detection device 1 is improved, in terms of (a) the durability of the expansion valve 100 and the stepping motor 60, or (b) the vibration and noise generation reduced during the retightening operation.

As explained above, the rotational position detection device 1 for the stepping motor 60 of the first embodiment is used for the stepping motor 60 having the rotor 30 including the plurality of magnet pillars 33 arranged in an annular shape. The rotational position detection device 1 includes the magnetic flux sensor 52 that has a detection range for detecting magnetism at a predetermined position, and detects changes in magnetism caused by the rotation of the rotor 30.

As shown in FIG. 2, the plurality of magnet pillars 33 are arranged so that their polarity changes periodically according to a rotational direction of the rotor 30. The rotor 30 has a peculiar magnetic flux point 35 that interferes with the periodicity of the response waveform formed by the magnetism of the plurality of magnet pillars 33 detected by the magnetic flux sensor 52 for the time in which the rotor 30 makes one rotation.

Therefore, according to the rotational position detection device 1 for the stepping motor 60, when the rotor 30 is rotating normally, the response waveform of the magnetic flux sensor 52 that is output in the time that the rotor 30 makes one rotation includes the waveform caused by the peculiar magnetic flux point 35. The waveform caused by the peculiar magnetic flux point 35 will interfere with the periodicity of the waveform in the response waveform. In other words, the presence or absence of a waveform caused by the peculiar magnetic flux point 35 can be used to determine whether it is in a situation in which the response waveform output from the magnetic flux sensor 52 is showing a pseudo-normal waveform that changes periodically as in the normal time, even though the stepping motor 60 is actually out of step or is abnormally stopping.

That is, the rotational position detection device 1 for the stepping motor 60 can quickly detect the rotation abnormality of the stepping motor 60, which is a pseudo-normal waveform, by detecting the presence or absence of a waveform caused by the peculiar magnetic flux point 35 in the response waveform from the magnetic flux sensor 52, and can control the progress of the rotation abnormality.

As shown in FIG. 2, in the first embodiment, the peculiar magnetic flux point 35 of the rotor 30, which includes a part that passes the detection range of the magnetic flux sensor 52 in one rotation of the rotor 30, is composed of a combination of (a) the magnetic part 36 and (b) the non-magnetic part 38, which is configured to exhibit non-magnetic property.

The combination of the magnetic part 36 and the non-magnetic part 38 can interfere with the periodicity of the magnetic flux change in the rotor 30 with a simple configuration, thereby improving the speed and reliability regarding the detection of the rotation abnormality related to the pseudo-normal waveform.

Further, in the first embodiment, the magnetic part 36 of the rotor 30 is composed of the extension part 37 that is an axial extension of the plurality of magnet pillars 33 arranged along the outer circumference of the rotor 30. The plurality of magnet pillars 33 is composed of magnet pillars 33N of N pole and magnet pillars 33S of S pole, as alternately arranged magnet pillars 33N and 33S.

Thus, in the first embodiment, the magnetic part 36 in the rotor 30 can be realized with a relatively simple configuration. When the rotor 30 rotates and the magnetic part 36 passes through the detection range of the magnetic flux sensor 52, the extension part 37 of the magnet pillar 33N and the extension part 37 of the magnet pillar 33S pass alternately. As a result, when the magnetic part 36 passes through the detection range of the magnetic flux sensor 52, the magnetic flux intensity pertaining to the N pole and the magnetic flux intensity pertaining to the S pole intensify periodically, and thus the periodicity of the magnetic flux change is detectable in the response waveform of the magnetic flux sensor 52. In other words, by using the extension part 37 of the plurality of magnet pillars 33 to form the magnetic part 36, it is also possible to detect the rotation abnormality of the rotor 30 where the length of the period of the response waveform of the magnetic flux sensor 52 changes.

As shown in FIG. 6, according to the rotational position detection device 1 of the first embodiment, the presence or absence of the peculiar waveform Sw in the response waveform output from the magnetic flux sensor 52 in one rotation of the rotor 30 determines whether a rotation abnormality of the rotor 30 pertaining to a pseudo-normal waveform is occurring. When the response waveform from the magnetic flux sensor 52 includes the peculiar waveform Sw, the rotation of the rotor 30 is determined to be normal, and when the peculiar waveform Sw is not included therein, the rotation of the rotor 30 pertaining to a pseudo-normal waveform is determined to be abnormal.

Therefore, according to the rotational position detection device 1 of the first embodiment, the occurrence of the rotation abnormality related to the pseudo-normal waveform, which was difficult to detect quickly in the past, is detectable quickly and reliably by the presence or absence of peculiar waveform Sw in the response waveform from the magnetic flux sensor 52.

The rotational position detection device 1 of the first embodiment is applied to the expansion valve 100 that uses the driving force of the stepping motor 60 to move the valve plug 25. As shown in FIG. 7, the rotational position detection device 1 identifies the position of the valve plug 25 in the expansion valve 100 by counting the number of peculiar waveforms Sw detected as the rotor 30 rotates in relation to a rotational direction of the rotor 30.

According to the first embodiment, the position of the valve plug 25 in the expansion valve 100 can be accurately identified in conjunction with the rotational position of the rotor 30 by effectively utilizing the configuration of the peculiar magnetic flux point 35 formed in the rotor 30.

Further, the rotational position detection device 1 of the first embodiment can identify the position of the valve plug 25 relative to the valve seat 15 using the value of the peculiar point counter that counts the peculiar waveform Sw detected as the rotor 30 rotates. Further, during the valve closing operation of the expansion valve 100, when the valve plug 25 comes closer to the valve seat 15 based on the value of the peculiar point counter, the rotation speed of the rotor 30 is reduced.

In such manner, in the first embodiment, the speed at which the valve plug 25 contacts the valve seat 15 is reduced, thereby making a soft contact between the valve seat 15 and the valve plug 25. In the expansion valve 100, the valve seat 15 and the valve plug 25 contact each other with high frequency, and the deformation and wear caused by the contact affect the life of the expansion valve 100. The rotational position detection device 1 can reduce deformation of the valve seat 15 and valve plug 25 by soft contact between the valve seat 15 and the valve plug 25, thereby extending the life of the expansion valve 100.

Further, according to the rotational position detection device 1 of the first embodiment, as shown in FIG. 9, the amount of retightening is adjusted using (a) the value of the peculiar point counter that counts the peculiar waveform Sw detected as the rotor 30 rotates and (b) the control instruction from the air conditioning controller 80. The number in the peculiar point counter indicates the actual rotational position of the rotor 30, while the control instruction indicates the position of the rotor 30 as recognized on the controller side, i.e., by the air conditioning controller 80. The rotational position detection device 1 of the first embodiment adjusts the amount of retightening according to the magnitude of the amount of deviation between the actual rotational position of the rotor 30 and the recognized position of the rotor 30.

As shown in FIG. 9, by adjusting the amount of retightening according to the magnitude of the amount of deviation, excessive retightening operations are not performed to correct a small amount of deviation, thereby preventing the excessive load on the stepping motor 60 and the like. Further, according to the rotational position detection device 1, the durability of the expansion valve 100 and the stepping motor 60 is improvable by adjusting the amount of retightening by effectively utilizing the configuration, i.e., the peculiar magnetic flux point 35 of the rotor 30.

### Second Embodiment

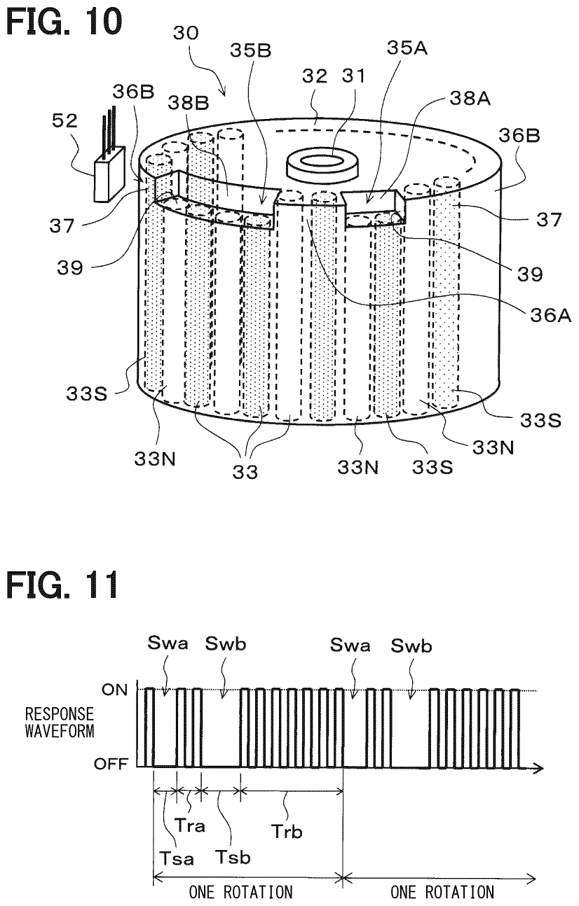

Next, the second embodiment, which differs from the embodiment described above, is described with reference to FIGS. 10 through 12. In the rotational position detection device 1 for the stepping motor 60 of the second embodiment, the configuration of the peculiar magnetic flux point 35 in the rotor 30 and the control mode using the peculiar magnetic flux point 35 are different from the first embodiment described above. Other configurations (e.g., the body 10, the stator 51 in the stepping motor 60, the lower case 50, etc.) of the rotational position detection device 1 and the expansion valve 100 of the second embodiment are the same as those of the first embodiment described above, and thus will not be described again.

As in the first embodiment, the rotational position detection device 1 of the second embodiment is used for the stepping motor 60 as a drive source for moving the valve plug 25 in the expansion valve 100.

As shown in FIG. 10, the second embodiment differs from the first embodiment in the configuration of the rotor 30 of the stepping motor 60. Unlike the first embodiment, the upper surface side portion of the rotor 30 in the second embodiment has a plurality of peculiar magnetic flux points 35 formed thereon. Specifically, the rotor 30 of the second embodiment has a first peculiar magnetic flux point 35A and a second peculiar magnetic flux point 35B formed thereon.

The first peculiar magnetic flux point 35A and the second peculiar magnetic flux point 35B, like the peculiar magnetic flux point 35 of the first embodiment, are composed of the magnetic part 36 combined with the non-magnetic part 38 indicating non-magnetic property in a part of the rotor 30 that passes through the detection range of the magnetic flux sensor 52. The configuration of the magnetic part 36 and the non-magnetic part 38 is basically the same as the one in the first embodiment.

In the rotor 30 of the second embodiment, the parts passing through the detection range of the magnetic flux sensor 52 are formed in an order of the first non-magnetic part 38A, the first magnetic part 36A, the second non-magnetic part 38B, and the second magnetic part 36B in the circumferential direction.

The first non-magnetic part 38A is composed of the notch 39 of the upper surface side of the rotor 30, which is a notch notching therefrom (a) an upper surface side of one magnet pillar 33S and (b) an upper surface side of one adjacent magnet pillar 33N.

The first magnetic part 36A is composed of (a) an extension part 37 of the magnet pillar 33S adjacent to the magnet pillar 33N arranged below the first non-magnetic part 38A and (b) an extension part 37 of the magnet pillar 33N adjacent to the extension part 37 of the magnet pillar 33S.

The second non-magnetic part 38B is composed of the notch 39 arranged adjacent to the first magnetic part 36A. The notch 39, which constitutes the second non-magnetic part 38B, is formed by notching the extension part 37 of the four magnet pillars 33 (i.e., two magnet pillars 33N and two magnet pillars 33S) out of the upper surface side of the rotor 30.

The second magnetic part 36B is formed at a position between the second non-magnetic part 38B and the first non-magnetic part 38A of the upper surface side of the rotor 30. As in the first embodiment described above, the rotor 30 in the second embodiment has 12 pieces of the magnet pillars 33N and 12 pieces of the magnet pillars 33S, arranged so that the magnet pillars 33N and 33S alternate with each other. Thus, the second magnetic part 36B is composed of the extension parts of eight magnet pillars 33N and the extension parts of eight magnet pillars 33S.

According to the rotor 30 of the second embodiment, in the first magnetic part 36A and the second magnetic part 36B, the number of extension parts 37 comprising each is different. Therefore, in the response waveform of the magnetic flux sensor 52 when the rotor 30 of the second embodiment makes one rotation, the number of normal periods Pr, which is a period of switching between ON and OFF signals, will differ between (a) the part corresponding to the first magnetic part 36A and (b) the part corresponding to the second magnetic part 36B.

Also, according to the rotor 30 of the second embodiment, the number of extension parts 37 of the magnet pillar 33 that are notched at the notches 39 pertaining to the first non-magnetic part 38A and the second non-magnetic part 38B is respectively different. As a result, in the response waveform of the magnetic flux sensor 52 when the rotor 30 of the second embodiment makes one rotation, a difference between (a) the length of the first peculiar waveform Swa pertaining to the first non-magnetic part 38A and (b) the length of the second peculiar waveform Swb pertaining to the second non-magnetic part 38B appears. The difference between (a) the length of the first peculiar waveform Swa and (b) the length of the second peculiar waveform Swb in the response waveform corresponds to a difference in a physical shape of the first non-magnetic part 38A and the second non-magnetic part 38B.

In the rotor 30 of the second embodiment having the above-described configuration, a configuration of the response waveform output from the magnetic flux sensor 52 differs according to a rotational direction of the rotor 30. First, the configuration of the response waveform when the rotor 30 is rotated in a predetermined direction (i.e., open valve direction) during the valve opening operation of the expansion valve 100 is explained with reference to FIG. 11.

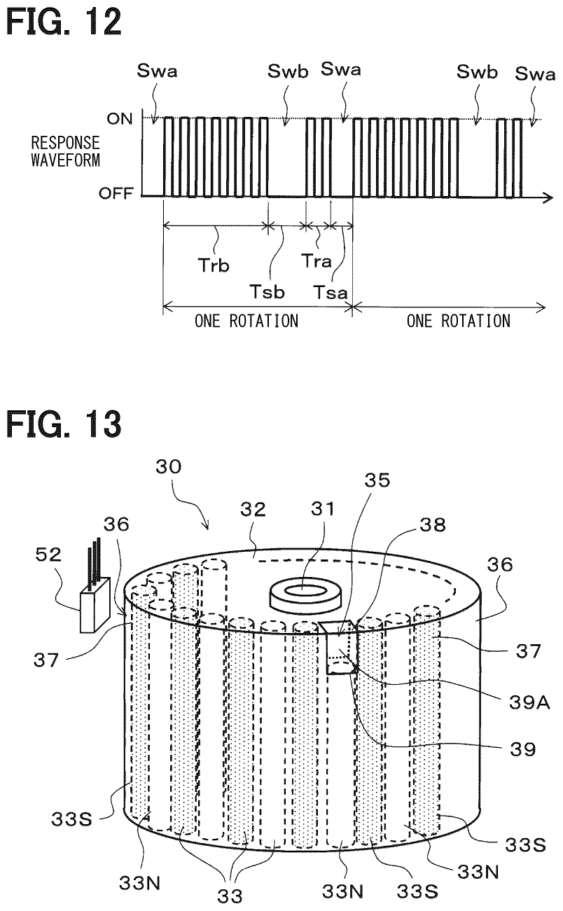

In the explanation of FIGS. 11 and 12, the period during which the first peculiar waveform Swa is output in the response waveform of the magnetic flux sensor 52 in one rotation of the rotor 30 is called as a first peculiar waveform period Tsa, and the period during which the second peculiar waveform Swb is output is called as a second peculiar waveform period Tsb.

Further, in the response waveform of the magnetic flux sensor 52 in one rotation of the rotor 30, the period in which the ON and OFF signals switch at the normal period Pr as the first magnetic part 36A passes through the detection range is called as a first normal period Tra. The period during which the ON and OFF signals switch at the normal period Pr as the second magnetic part 36B passes through the detection range of the magnetic flux sensor 52 is called as a second normal period Trb.

For example, when the rotor 30 is rotated in the open valve direction during the valve opening operation of the expansion valve 100, the first non-magnetic part 38A, the first magnetic part 36A, the second non-magnetic part 38B, and the second magnetic part 36B of the rotor 30 pass through the detection range of the magnetic flux sensor 52 in the above-written order. After the second magnetic part 36B, the first non-magnetic part 38A moves into the detection range of the magnetic flux sensor 52.

Thus, as shown in FIG. 11, the response waveform of the magnetic flux sensor 52 when the rotor 30 is rotated in the open valve direction (i.e., when making a forward rotation) is output in the following order: the first peculiar waveform period Tsa, the first normal period Tra, the second peculiar waveform period Tsb, and the second normal period Trb.

On the other hand, when performing the valve closing operation of the expansion valve 100 and rotating the rotor 30 in the opposite direction (i.e., close valve direction), the second magnetic part 36B, the second non-magnetic part 38B, the first magnetic part 36A, and the first non-magnetic part 38A of the rotor 30 pass through the detection range of the magnetic flux sensor 52 in the above-written order. After the first non-magnetic part 38A, the second magnetic part 36B moves into the detection range of the magnetic flux sensor 52.

In such case, as shown in FIG. 12, the response waveform of the magnetic flux sensor 52 when the rotor 30 is rotated in the close valve direction (i.e., when making a reverse rotation) is output in the following order: the second normal period Trb, the second peculiar waveform period Tsb, the first normal period Tra, and the first peculiar waveform period Tsa.

Thus, according to the rotational position detection device 1 of the second embodiment, the actual direction of rotation of the rotor 30 can be identified according to the configuration of the response waveform from the magnetic flux sensor 52 as the rotor 30 rotates. By using such configuration, the rotational position detection device 1 of the second embodiment can identify which of the valve opening operation and the valve closing operation of the expansion valve 100 is actually being performed.

In the second embodiment, as shown in FIG. 10, the configuration of the first non-magnetic part 38A and the second non-magnetic part 38B are different, and the configuration of the first magnetic part 36A and the second magnetic part 36B are different. However, such configuration is not the limiting one. Various configurations can be adopted for a rotor 30 having a plurality of peculiar magnetic flux points 35 per one rotation, as long as the arrangement of the plurality of peculiar magnetic flux points 35 is asymmetric in the forward and reverse rotations.

For example, even when the configuration of the first non-magnetic part 38A and the second non-magnetic part 38B are the same, a different configuration may be adopted for the first magnetic part 36A and the second magnetic part 36B. Similarly, even when the configuration of the first magnetic part 36A and the second magnetic part 36B are the same, a different configuration may be adopted for the first non-magnetic part 38A and the second non-magnetic part 38B.

Further, in the second embodiment, as in the first embodiment described above, the operation of the expansion valve 100 is performed in accordance with control instructions output from the air conditioning controller 80. Therefore, the rotational position detection device 1 of the second embodiment can compare (a) a rotational direction of the rotor 30 indicated by the control instruction from the air conditioning controller 80 with (b) a rotational direction of the rotor 30 identified from the response waveform of the magnetic flux sensor 52.

In such manner, the rotational position detection device 1 of the second embodiment can determine whether the rotor 30 is rotating according to the instruction of the drive control side (i.e., from the air conditioning controller 80), and can output an error signal when the rotor 30 is rotating in a direction different from the control instruction.

For example, an error signal can be output to the air conditioning controller 80 to inform the user that an error has occurred in the expansion valve 100 including the stepping motor 60. Also, by outputting an error signal to the air conditioning controller 80, the operation mode of the refrigeration cycle including the expansion valve 100 can be changed or operation can be stopped. When the operation mode of the stepping motor 60 is different from the control instruction on the drive control side (i.e., on the air conditioning controller 80 side), it is assumed that the operation of the expansion valve 100 and the refrigeration cycle will be seriously disturbed. Therefore, the error can be quickly resolved by changing the operation mode of the refrigeration cycle or stopping the operation, with minimal impact on other components in the refrigeration cycle.

As explained above, according to the rotational position detection device 1 of the second embodiment, even when the plurality of peculiar magnetic flux points 35 are formed in the rotor 30, the same effects exerted by the same configuration and operation as in the above-described embodiment are achievable.

As shown in FIG. 10, the first peculiar magnetic flux point 35A and the second peculiar magnetic flux point 35B are formed as a plurality of peculiar magnetic flux points 35 in the rotor 30 of the stepping motor 60 of the second embodiment. As shown in FIGS. 11 and 12, the plurality of peculiar magnetic flux points 35 are arranged so that the output period of the plurality of peculiar waveforms Sw in the response waveform when the rotor 30 rotates forward is different from that of the plurality of peculiar waveforms Sw in the response waveform when the rotor 30 rotates in reverse.

Therefore, according to the rotational position detection device 1 of the second embodiment, a rotational direction in which the rotor 30 is actually rotating can be identified by referring to the output period of the peculiar waveform in the response waveform from the magnetic flux sensor 52.

Also, the rotational position detection device 1 of the second embodiment performs the drive control of the stepping motor 60 according to the control instruction from the air conditioning controller 80. Therefore, the rotational position detection device 1 can compare a rotational direction of the rotor 30, as indicated by the control instruction from the air conditioning controller 80, with a rotational direction of the rotor 30 identified from the response waveform of the magnetic flux sensor 52. As a result, it is possible to identify whether the drive control of the stepping motor 60 is realized as per the control instruction, and when the control instruction and the actual situation do not match, an error signal can be output.

### Third Embodiment

The third embodiment, which differs from the embodiments described above, is then described with reference to FIG. 13. In the rotational position detection device 1 for the third embodiment, the configuration of the non-magnetic part 38 in the rotor 30 of the stepping motor 60 is different from the first embodiment described above. The other configuration of the third embodiment (the body 10, the stator 51, the lower case 50, and the like) are the same as those of the first embodiment described above, thereby redundant explanation thereof will be omitted.

As shown in FIG. 13, the rotor 30 of the stepping motor 60 of the third embodiment has the non-magnetic part 38 formed thereon to constitute the peculiar magnetic flux point 35. The non-magnetic part 38 of the third embodiment is composed of the notch 39 that is notched out of the upper surface side of the rotor 30, including the upper surface side of one magnet pillar 33N.

Here, just like in the embodiment described above, when the non-magnetic part 38 of the rotor 30 is composed of the notch 39 in which a part of the rotor core 32 and the magnet pillar 33 is notched, the weight of the notched part will be reduced, which may cause bias in the weight and rotation balance in the rotor 30.

In view of the above-described point, the third embodiment adopts a configuration in which a non-magnetic material 39A is used to fill a part which is notched from the rotor 30 as the notch 39 when configuring the non-magnetic part 38 of the rotor 30. Various materials can be employable as the non-magnetic material 39A, as long as the material exhibits the same weight and non-magnetic property as the part notched as the notch 39.

Such configuration allows the third embodiment to balance the weight and rotation of the rotor 30 while ensuring its function as the non-magnetic part 38 and the peculiar magnetic flux point 35.

As explained above, according to the rotational position detection device 1 of the third embodiment, even when the configuration of the non-magnetic part 38 for forming the peculiar magnetic flux point 35 of the rotor 30 is changed, the same effects are achievable as those from the configuration and operation common to the above-described, preceding embodiments.

As shown in FIG. 13, in the third embodiment, the non-magnetic material 39A is filled in the notch 39 of the rotor core 32 and the magnet pillar 33, which is a partially-notched part as the non-magnetic part 38 to constitute the peculiar magnetic flux point 35 in the rotor 30.

In such manner, according to the rotational position detection device 1 of the third embodiment, the function of the non-magnetic part 38 in the rotor 30 is secured, and at the same time, the weight balance and rotational balance of the rotor 30, which is biased due to the formation of the notch 39, is adjustable.

The present disclosure is not limited to the embodiments described above, and various modifications can be made as follows within a range not departing from the spirit of the present disclosure.

In the embodiments described above, the rotational position detection device for a stepping motor of the present disclosure is applied to the expansion valve 100 used in a refrigeration cycle. However, configuration is not limited to the above-described mode. It is applicable to various devices as long as they are having the stepping motor 60. For example, a rotational position detection device for a stepping motor may be applied to a valve device such as an open/close valve or a multi-way valve.

Further, in the embodiments described above, a control process shown in FIGS. 8 and 9 is described as an operation control for bringing the valve plug 25, which corresponds to the movable member, into contact with the valve seat 15 which serves as the regulating unit. However, the control process is not limited to the above-described mode of operation. That is, the control process in FIGS. 8 and 9 is applicable to various devices, as long as the device is configured to move a specific member along a predetermined movement path by rotation of the rotor 30 in the stepping motor 60, for contacting the regulating unit arranged on the movement path.

The non-magnetic part 38 in the rotor 30 of the first embodiment described above is composed of the notch 39 with a part of the magnet pillars 33N and 33S notched therefrom. However, the configuration of the magnet pillars 33 that are notched when configuring the notch 39 is not limited to the configuration described above. For example, the non-magnetic part 38 may be configured using the notch 39 with a part of the magnet pillar 33S notched therefrom.

In case where the non-magnetic part 38 is configured using the notch 39 in which a plurality of adjacent magnet pillars 33 are notched, in the embodiment described above, an even number of magnet pillars 33 (i.e., equal number of the magnet pillars 33N and 33S) are notched. However, the configuration is not limited to the above. When configuring the notch 39, it is also possible to adopt a configuration in which an odd number of the magnet pillars 33 (i.e., the number of one of the magnet pillars 33N or 33S is greater than the other) are notched.

In the embodiment described above, the magnetic part 36 in the rotor 30 is formed by the extension part 37 made of the same material as the plurality of magnet pillars 33S made of resin magnets. However, the configuration is not limited to the above. The magnetic part 36 does not have to have the same spacing and arrangement as the plurality of magnet pillars 33S for rotating the rotor 30, but may be configured with a plurality of magnets at different intervals.

Further, in the embodiment described above, the magnetic flux sensor 52 is arranged on one side of the rotation shaft 31 of the rotor 30 (i.e., on an upper side in FIGS. 2, 10, and 13) to have a detection range toward the center of rotation of the rotor 30. However, the configuration is not limited to the above. As long as the magnetic flux sensor 52 is capable of detecting changes of magnetism caused by the rotation of the rotor 30, arrangement of the magnetic flux sensor 52 may be on the other side (i.e., on the lower side in FIG. 2, or the like) of the rotation shaft 31 of the rotor 30. Further, it is also possible to adopt a configuration in which multiple magnetic flux sensors 52 are arranged for one rotor 30. For example, the magnetic flux sensor 52 with a detection range on the upper part of the rotor 30 and the magnetic flux sensor 52 with a detection range on the lower part of the rotor 30 may be simultaneously used.

Further, the detection range of the magnetic flux sensor 52 in the embodiment described above is set toward the inner side of the rotor 30 in the radial direction, but the configuration is not limited to the above. The detection range of the magnetic flux sensor 52 may be set along the axial direction of the rotor 30, as long as the detection range is set to face the rotor 30, for detecting changes in the magnetic flux caused by the rotation of the rotor 30.

Further, in the second embodiment, as shown in FIG. 10, a plurality of non-magnetic part 38 and a plurality of peculiar magnetic flux points 35 are configured by forming a plurality of notches 39 on the rotor 30. The arrangement of the plurality of notches 39 on the rotor 30 is not limited to the above mentioned manner. For example, the plurality of notches 39 on the rotor 30 may be arranged so that the rotor 30 is balanced in weight and rotation. In such case, the size of the notches 39 (i.e., the number of magnet pillars 33 to be notched) may also be determined to balance the weight and rotation of the rotor 30.

Features of the rotational position detection device for a stepping motor disclosed in the present description will be described as follows.

### Item 1

A rotational position detection device is for a stepping motor (60). The stepping motor includes a rotor (30) with a plurality of magnets (33, 33S, 33N) arranged in an annular shape. The rotational position detection device is configured to detect a rotational position of the rotor and includes: a magnetic flux sensor (52) having a detection range at a predetermined position for detecting magnetism and configured to detect a change in magnetism caused by rotation of the rotor. The magnets are arranged so that a polarity changes periodically according to a rotational direction of the rotor. The rotor has a peculiar magnetic flux point (35, 35A, 35B) configured to interfere with a periodicity of a response waveform, which is formed by the magnetism of the magnets detected by the magnetic flux sensor, in a period of time for one rotation of the rotor.

### Item 2

The rotational position detection device for a stepping motor according to item 1, in which the peculiar magnetic flux point is a part of the rotor, which passes through the detection range of the magnetic flux sensor when the rotor makes one rotation, and formed of a combination of a magnetic part (36), which is formed of a magnetic material, and a non-magnetic part (38), which is formed of a non-magnetic material that exhibits non-magnetic property.

### Item 3

The rotational position detection device for a stepping motor according to item 2, in which the magnets include a plurality of magnet pillars arranged along a circumference of the rotor, and the magnetic part (36) includes an extension part (37) which is an extension of the magnet pillar in an axial direction of the rotor.

### Item 4

The rotational position detection device for a stepping motor according to any one of items 1 to 3, further including: a control unit (53) configured to control drive of the stepping motor, in which the control unit is configured to determine that the stepping motor operates normally, when the response waveform, which is output from the magnetic flux sensor in one rotation of the rotor, includes at least one peculiar waveform (Sw, Swa, Swb) caused by the peculiar magnetic flux point, and determine that the stepping motor has an abnormality, when the response waveform, which is output from the magnetic flux sensor in one rotation of the rotor, does not include the peculiar waveform.

### Item 5

The rotational position detection device for a stepping motor according to according to any one of items 1 to 4, further including: a movable member (25) movable along a predetermined movement path by a driving force generated by rotation of the rotor; a regulating unit (15) provided in the movement path and configured to regulate movement of the movable member; and a control unit (53) configured to control drive of the stepping motor, in which the control unit is configured to count a peculiar waveform (Sw), which is caused by the peculiar magnetic flux point and included in the response waveform output from the magnetic flux sensor, identify a position of the movable member, which is moved by rotation of the rotor, based on a result of counting of the peculiar waveform, and control a rotation speed of the rotor, such that the rotation speed, when the identified position of the movable member from the regulating unit is in a predetermined range, is decreased compared to the rotation speed of the rotor, when the identified position of the movable member from the regulating unit is away from the predetermined range.

### Item 6

The rotational position detection device for a stepping motor according to according to any one of items 1 to 5, further including: a movable member (25) movable along a predetermined movement path by a driving force generated by rotation of the rotor; a regulating unit (15) provided in the movement path and configured to regulate movement of the movable member; and a control unit (53) configured to control drive of the stepping motor, in which the control unit is configured to count a peculiar waveform (Sw), which is caused by the peculiar magnetic flux point and included in the response waveform output from the magnetic flux sensor, identify a position of the movable member, which is moved by rotation of the rotor, based on a result of counting of the peculiar waveform, estimate the position of the movable member, which is moved by rotation of the rotor, based on a number of application of an excitation current to the stepping motor, and identify an amount of position deviation of the movable member, based on the identified position of the movable member, which is identified based on the result of counting of the peculiar waveform, and the estimated position of the movable member, which is estimated based on the number of application of the excitation current, and adjust an amount of rotation of the rotor according to the identified amount of position deviation of the movable member.

### Item 7

The rotational position detection device for a stepping motor according to any one of items 1 to 6, further including: a control unit (53) configured to control drive of the stepping motor, in which the rotor has a plurality of the peculiar magnetic flux points (35A, 35B), the peculiar magnetic flux points are provided to a part of the rotor, which passes through the detection range of the magnetic flux sensor in one rotation of the rotor, the peculiar magnetic flux points are arranged, such that an output period of the peculiar waveform, which is caused by the peculiar magnetic flux points in the response waveform when the rotor rotates forward, differs from an output period of the peculiar waveform in the response waveform when the rotor rotates in reverse, and the control unit (53) is configured to identify a rotational direction of the rotor according to the output period of the peculiar waveform (Swa, Swb) in the response waveform output from the magnetic flux sensor.

### Item 8

The rotational position detection device for a stepping motor according to item 7, in which the control unit (53) is configured to determine whether a rotational direction instruction, which is input to the stepping motor, match a rotational direction of the rotor, which is identified according to the output period of the peculiar waveform in the response waveform, and output an error signal, which indicates that the stepping motor has an abnormality, when the identified rotational direction of the rotor does not match the rotational direction instruction.

Although the present disclosure has been described in accordance with the embodiments, it is understood that the present disclosure is not limited to such embodiments and structures. The present disclosure includes various modifications or deformations within an equivalent range. Further, while various combinations and configurations, together with other combinations and configurations, including one or more element or less than one element, are also within the spirit and scope of the present disclosure.

What is claimed is:

1. A rotational position detection device for a stepping motor, the stepping motor including a rotor with a plurality of magnets arranged in an annular shape, the rotational position detection device configured to detect a rotational position of the rotor and comprising:
a magnetic flux sensor having a detection range at a predetermined position for detecting magnetism and configured to detect a change in magnetism caused by rotation of the rotor, wherein
the magnets are arranged so that a polarity changes periodically according to a rotational direction of the rotor, and
the rotor has a peculiar magnetic flux point configured to interfere with a periodicity of a response waveform, which is formed by the magnetism of the magnets detected by the magnetic flux sensor, in a period of time for one rotation of the rotor.

2. The rotational position detection device for a stepping motor according to claim 1, wherein
the peculiar magnetic flux point is
a part of the rotor, which passes through the detection range of the magnetic flux sensor when the rotor makes one rotation, and
formed of a combination of a magnetic part, which is formed of a magnetic material, and a non-magnetic part, which is formed of a non-magnetic material that exhibits non-magnetic property.

3. The rotational position detection device for a stepping motor according to claim 2, wherein
the magnets include a plurality of magnet pillars arranged along a circumference of the rotor, and
the magnetic part includes an extension part which is an extension of the magnet pillar in an axial direction of the rotor.

4. The rotational position detection device for a stepping motor according to claim 1, further comprising:
a control unit configured to control drive of the stepping motor, wherein
the control unit is configured to
determine that the stepping motor operates normally, when the response waveform, which is output from the magnetic flux sensor in one rotation of the rotor, includes at least one peculiar waveform caused by the peculiar magnetic flux point, and
determine that the stepping motor has an abnormality, when the response waveform, which is output from the magnetic flux sensor in one rotation of the rotor, does not include the peculiar waveform.

5. The rotational position detection device for a stepping motor according to claim 1, further comprising:
a movable member movable along a predetermined movement path by a driving force generated by rotation of the rotor;
a regulating unit provided in the movement path and configured to regulate movement of the movable member; and
a control unit configured to control drive of the stepping motor, wherein
the control unit is configured to
count a peculiar waveform, which is caused by the peculiar magnetic flux point and included in the response waveform output from the magnetic flux sensor,
identify a position of the movable member, which is moved by rotation of the rotor, based on a result of counting of the peculiar waveform, and
control a rotation speed of the rotor, such that the rotation speed, when the identified position of the movable member from the regulating unit is in a predetermined range, is decreased compared to the rotation speed of the rotor, when the identified position of the movable member from the regulating unit is away from the predetermined range.

6. The rotational position detection device for a stepping motor according to claim 1, further comprising:
a movable member movable along a predetermined movement path by a driving force generated by rotation of the rotor;
a regulating unit provided in the movement path and configured to regulate movement of the movable member; and
a control unit configured to control drive of the stepping motor, wherein
the control unit is configured to
count a peculiar waveform, which is caused by the peculiar magnetic flux point and included in the response waveform output from the magnetic flux sensor,
identify a position of the movable member, which is moved by rotation of the rotor, based on a result of counting of the peculiar waveform,
estimate the position of the movable member, which is moved by rotation of the rotor, based on a number of application of an excitation current to the stepping motor,
identify an amount of position deviation of the movable member, based on the identified position of the movable member, which is identified based on the result of counting of the peculiar waveform, and the estimated position of the movable member, which is estimated based on the number of application of the excitation current, and
adjust an amount of rotation of the rotor according to the identified amount of position deviation of the movable member.

7. The rotational position detection device for a stepping motor according to claim 1, further comprising:
a control unit configured to control drive of the stepping motor, wherein
the rotor has a plurality of the peculiar magnetic flux points,
the peculiar magnetic flux points are provided to a part of the rotor, which passes through the detection range of the magnetic flux sensor in one rotation of the rotor,
the peculiar magnetic flux points are arranged, such that an output period of the peculiar waveform, which is caused by the peculiar magnetic flux points in the response waveform when the rotor rotates forward, differs from an output period of the peculiar waveform in the response waveform when the rotor rotates in reverse, and
the control unit is configured to identify a rotational direction of the rotor according to the output period of the peculiar waveform in the response waveform output from the magnetic flux sensor.

8. The rotational position detection device for a stepping motor according to claim 7, wherein
the control unit is configured to
determine whether a rotational direction instruction, which is input to the stepping motor, match a rotational direction of the rotor, which is identified according to the output period of the peculiar waveform in the response waveform, and
output an error signal, which indicates that the stepping motor has an abnormality, when the identified rotational direction of the rotor does not match the rotational direction instruction.
